(19) United States
(12) Patent Application Publication
(10) Pub. No.: US 2026/0212806 A1
(43) Pub. Date: Jul. 23, 2026

(54) DISPLAY DEVICE AND ELECTRONIC DEVICE INCLUDING THE DISPLAY DEVICE

(71) Applicant: Samsung Display Co., LTD., Yongin-si (KR)

(72) Inventors: KWIHYUN KIM, Yongin-si (KR); SEHYUN LEE, Yongin-si (KR); KYUNGHOON CHUNG, Yongin-si (KR); JI-SUN KIM, Yongin-si (KR); SUNHWA LEE, Yongin-si (KR)

(21) Appl. No.: 19/390,590

(22) Filed: Nov. 16, 2025

(30) Foreign Application Priority Data
Jan. 17, 2025 (KR) 10-2025-0007291

(51) Int. Cl. G09G 3/32

(52) U.S. Cl. CPC G09G 3/32; G09G 2310/0267; G09G 2310/0275; G09G 2310/08; G09G 2320/0633; G09G 2330/021

(57) ABSTRACT

A display device may include a display panel including first to third pixels which emit light of different colors, a data driver, a gate driver, a first emission driver which outputs a first emission signal to the first pixel, a second emission driver which outputs a second emission signal to the second pixel, a third emission driver which outputs a third emission signal to the third pixel, and a driving controller. The driving controller may determine a first emission duty of the first emission signal based on an emission efficiency of the first pixel, determine a second emission duty of the second emission signal based on an emission efficiency of the second pixel, and determine a third emission duty of the third emission signal based on an emission efficiency of the third pixel.

This application claims priority to Korean Patent Application No. 10-2025-0007291, filed on Jan. 17, 2025, and all the benefits accruing therefrom under 35 U.S.C. § 119, the content of which in its entirety is herein incorporated by reference.

### BACKGROUND

### 1. Field

Embodiments supported by aspects of the present disclosure relate to a display device and an electronic device including the display device.

### 2. Description of the Related Art

A display device may include pixels. The pixels may be PWM pixels driven by plus width modulation (PWM) method or PAM pixels driven by pulse amplitude modulation (PAM) method. In some aspects, the pixels may receive the same emission signal.

The PWM pixel may express a luminance by fixing a magnitude of a current and adjusting an emission duty of an emission signal. In a low gray-level period, the emission duty of the emission signal may be decreased. In an example in which a delay occurs in a rising time or a falling time of the emission signal, the current, which flows in the PWM pixel, may not reach a target current by a decreased emission duty. Accordingly, the PWM pixel may not accurately emit light at the target luminance.

The PAM pixels may express the luminance by fixing the emission duty and adjusting the magnitude of the current. Emission efficiency (or referred to as an external quantum efficiency (EQE)) of each of a PAM pixel which emits light at a red color, a PAM pixel which emits light at a blue color, and a PAM pixel which emits light at a green color may be different from each other. Accordingly, when the emission signal, which has the same emission duty, is applied to the PAM pixel which emits light at the red color, the PAM pixel which emits light at the blue color, and the PAM pixel which emits light at the green color, The PAM pixels may not emit light at optimal emission efficiency and then power consumption of the display device may be increased.

### SUMMARY

An object of the present disclosure is to provide a display device having reduced power consumption and improved luminance expression by increasing emission efficiency of a pixel.

Another object of the present disclosure is to provide an electronic device including the display device.

However, objects of the present disclosure are not limited to the above objects, and may be variously extended without departing from the spirit and scope of the present disclosure.

According to embodiments, a display device may include a display panel including a first pixel which emits light of a first color, a second pixel which emits light of a second color, and a third pixel which emits light of a third color, a data driver which outputs a data voltage to the first pixel, the second pixel, and the third pixel, a gate driver which outputs a gate signal to the first pixel, the second pixel, and the third pixel, a first emission driver which outputs a first emission signal to the first pixel, a second emission driver which outputs a second emission signal to the second pixel and the third pixel, and a driving controller which controls the data driver, the gate driver, the first emission driver, and the second emission driver. The driving controller may determine a first emission duty of the first emission signal based on an emission efficiency of the first pixel and determine a second emission duty of the second emission signal based on an emission efficiency of the second pixel. The driving controller may control the first emission driver such that the first emission driver outputs the first emission signal according to the first emission duty, and further, control the second emission driver such that the second emission driver outputs the second emission signal according to the second emission duty.

In an embodiment, the driving controller may determine the first emission duty based on a first maximum efficiency which is a maximum value of the emission efficiency of the first pixel within an emission efficiency determination range and determine the second emission duty based on a second maximum efficiency which is a maximum value of the emission efficiency of the second pixel within the emission efficiency determination range.

In an embodiment, the driving controller may determine a first current density corresponding to the first maximum efficiency, determine the first emission duty based on the first current density, determine a second current density corresponding to the second maximum efficiency, and determine the second emission duty based on the second current density.

In an embodiment, the driving controller may determine a first maximum current, which is a maximum value of a current which flows through the first pixel, based on the first current density and determine a second maximum current, which is a maximum value of a current which flows through the second pixel, based on the second current density.

In an embodiment, the driving controller may determine the first emission duty based on the first maximum current and determine the second emission duty based on the second maximum current.

In an embodiment, the first current density may be greater than the second current density, the first maximum current may be greater than the second maximum current, and the first emission duty may be less than the second emission duty.

According to embodiments, a display device may include a display panel including a first pixel which emits light of a first color, a second pixel which emits light of a second color, and a third pixel which emits light of a third color, a data driver which outputs a data voltage to the first pixel, the second pixel, and the third pixel, a gate driver which outputs a gate signal to the first pixel, the second pixel, and the third pixel, a first emission driver which outputs a first emission signal to the first pixel, a second emission driver which outputs a second emission signal to the second pixel, a third emission driver which outputs a third emission signal to the third pixel, and a driving controller which controls the data driver, the gate driver, the first emission driver, the second emission driver, and the third emission driver. The driving controller may determine a first emission duty of the first emission signal based on an emission efficiency of the first pixel, determine a second emission duty of the second emission signal based on an emission efficiency of the second pixel, and determine a third emission duty of the third emission signal based on an emission efficiency of the third pixel. The driving controller may control the first emission driver such that the first emission driver outputs the first emission signal according to the first emission duty, control the second emission driver such that the second emission driver outputs the second emission signal according to the second emission duty, and control the third emission driver such that the third emission driver outputs the third emission signal according to the third emission duty.

In an embodiment, the driving controller may determine the first emission duty based on a first maximum efficiency which is a maximum value of the emission efficiency of the first pixel within an emission efficiency determination range, determine the second emission duty based on a second maximum efficiency which is a maximum value of the emission efficiency of the second pixel within the emission efficiency determination range, and determine the third emission duty based on a third maximum efficiency which is a maximum value of the emission efficiency of the third pixel within the emission efficiency determination range.

In an embodiment, the driving controller may determine a first current density corresponding to the first maximum efficiency, determines the first emission duty based on the first current density, determine a second current density corresponding to the second maximum efficiency, determine the second emission duty based on the second current density, determine a third current density corresponding to the third maximum efficiency, and determine the third emission duty based on the third current density.

In an embodiment, the driving controller may determine a first maximum current, which is a maximum value of a current which flows through the first pixel, based on the first current density, determine a second maximum current, which is a maximum value of a current which flows through the second pixel, based on the second current density, and determine a third maximum current, which is a maximum value of a current which flows through the third pixel, based on the third current density.

In an embodiment, the driving controller may determine the first emission duty based on the first maximum current, determine the second emission duty based on the second maximum current, and determine the third emission duty based on the third maximum current.

In an embodiment, the first current density may be greater than the second current density, the second current density may be greater than the third current density, the first maximum current may be greater than the second maximum current, the second maximum current may be greater than the third maximum current, the first emission duty may be less than the second emission duty, and the second emission duty may be less than the third emission duty.

In an embodiment, a driving mode of the display device may include a first driving mode, in which a maximum luminance for a maximum gray-level is a first maximum luminance, and a second driving mode, in which the maximum luminance for the maximum gray-level is a second maximum luminance higher than the first maximum luminance, the first emission duty of the first emission signal in the second driving mode may be greater than the first emission duty of the first emission signal in the first driving mode, the second emission duty of the second emission signal in the second driving mode may be greater than the second emission duty of the second emission signal in the first driving mode, and the third emission duty of the third emission signal in the second driving mode may be greater than the third emission duty of the third emission signal in the first driving mode.

In an embodiment, the first maximum current in the first driving mode may be equal to the first maximum current in the second driving mode, the second maximum current in the first driving mode may be equal to the second maximum current in the second driving mode, and the third maximum current in the first driving mode may be equal to the third maximum current in the second driving mode.

According to embodiments, an electronic device may include a processor which generates an input control signal and input image data, a display panel including a first pixel which emits light of a first color, a second pixel which emits light of a second color, and a third pixel which emits light of a third color, a data driver which outputs a data voltage to the first pixel, the second pixel, and the third pixel, a gate driver which outputs a gate signal to the first pixel, the second pixel, and the third pixel, a first emission driver which outputs a first emission signal to the first pixel, a second emission driver which outputs a second emission signal to the second pixel, a third emission driver which outputs a third emission signal to the third pixel, and a driving controller which controls the data driver, the gate driver, the first emission driver, the second emission driver, and the third emission driver based on the input control signal and the input image data. the driving controller may determine a first emission duty of the first emission signal based on an emission efficiency of the first pixel, determine a second emission duty of the second emission signal based on an emission efficiency of the second pixel, and determine a third emission duty of the third emission signal based on an emission efficiency of the third pixel. The driving controller may control the first emission driver such that the first emission driver outputs the first emission signal according to the first emission duty, control the second emission driver such that the second emission driver outputs the second emission signal according to the second emission duty, and control the third emission driver such that the third emission driver outputs the third emission signal according to the third emission duty.

In an embodiment, the driving controller may determine the first emission duty based on a first maximum efficiency which is a maximum value of the emission efficiency of the first pixel within an emission efficiency determination range, determine the second emission duty based on a second maximum efficiency which is a maximum value of the emission efficiency of the second pixel within the emission efficiency determination range, and determine the third emission duty based on a third maximum efficiency which is a maximum value of the emission efficiency of the third pixel within the emission efficiency determination range.1

In an embodiment, the driving controller may determine a first current density corresponding to the first maximum efficiency, determine the first emission duty based on the first current density, determine a second current density corresponding to the second maximum efficiency, determine the second emission duty based on the second current density, determine a third current density corresponding to the third maximum efficiency, and determine the third emission duty based on the third current density.

In an embodiment, the driving controller may determine a first maximum current, which is a maximum value of a current which flows through the first pixel, based on the first current density, determine a second maximum current, which is a maximum value of a current which flows through the second pixel, based on the second current density, and determine a third maximum current, which is a maximum value of a current which flows through the third pixel, based on the third current density.

In an embodiment, the driving controller may determine the first emission duty based on the first maximum current, determine the second emission duty based on the second maximum current, and determine the third emission duty based on the third maximum current.

In an embodiment, the first current density may be greater than the second current density, the second current density may be greater than the third current density, the first maximum current may be greater than the second maximum current, the second maximum current may be greater than the third maximum current, the first emission duty may be less than the second emission duty, and the second emission duty may be less than the third emission duty.

Therefore, the driving controller of the display device may determine the current density based on the maximum emission efficiency of the pixel, and further, determine the emission duty of the emission signal to be applied to the pixel based on the current density determined based on the maximum emission efficiency of the pixel. Accordingly, the pixel may emit light with the maximum emission efficiency, and power consumption of the display device may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a diagram illustrating emission efficiency of each of pixels included in a display panel included in the display device of FIG. 1.

FIG. 3 is a circuit diagram illustrating an embodiment of the pixels included in the display panel included in the display device of FIG. 1.

FIG. 4 is a diagram illustrating an embodiment of an emission time and a maximum current of the pixels of FIG. 2.

FIG. 5 is a timing diagram illustrating an operation of the pixels of FIG. 2.

FIG. 6 is a diagram illustrating an embodiment of the emission time and the maximum current of the pixel of FIG. 2.

FIG. 7 is a timing diagram illustrating an operation of the pixels of FIG. 2.

FIG. 8 is a block diagram illustrating a display device according to embodiments.

FIG. 9 is a circuit diagram illustrating pixels included in a display panel included in the display device of FIG. 8.

FIG. 10 is a diagram illustrating an embodiment of an emission time and a maximum current of the pixels of FIG. 9.

FIG. 11 is a timing diagram illustrating an operation of the pixels of FIG. 9.

FIG. 12A is a diagram illustrating an embodiment of the emission time and the maximum current of the pixels of FIG. 9 according to a first driving mode of the display device of FIG. 8.

FIG. 12B is a diagram illustrating an embodiment of the emission time and the maximum current of the pixels of FIG. 9 according to a second driving mode of the display device of FIG. 8.

FIG. 13 is a timing diagram illustrating an operation of the pixels of FIG. 9 in the second driving mode of FIG. 12A.

FIG. 14 is a block diagram illustrating an electronic device according to embodiments.

FIG. 15 is a schematic diagram illustrating the electronic device of FIG. 14 according to embodiments.

### DETAILED DESCRIPTION

Hereinafter, display devices in accordance with embodiments will be described in more detail with reference to the accompanying drawings. The same reference numerals are used for the same components in the drawings, and redundant descriptions of the same components will be omitted.

Embodiments supported by the present disclosure will now be described more fully hereinafter with reference to the accompanying drawings, in which one or more example embodiments are illustrated. Aspects supported by the present disclosure may, however, be embodied in different forms and should not be construed as limited to the embodiments set forth herein. Rather, these example embodiments are provided so that this disclosure will be thorough and complete, and will fully convey the scope of example aspects of the invention to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, or components.

The terms “about” or “approximately” as used herein are inclusive of the stated value and include a suitable range of deviation for the particular value as determined by one of ordinary skill in the art, considering the measurement in question and the error associated with measurement of the particular quantity. The term “about” can mean within one or more standard deviations, or within ±30%, 20%, 10%, 5% of the stated value, for example.

The term “substantially,” as used herein, means approximately or actually. The term “substantially equal” means approximately or actually equal. The term “substantially the same” means approximately or actually the same. The term “substantially identical” means approximately or actually identical. The term “substantially perpendicular” means approximately or actually perpendicular.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

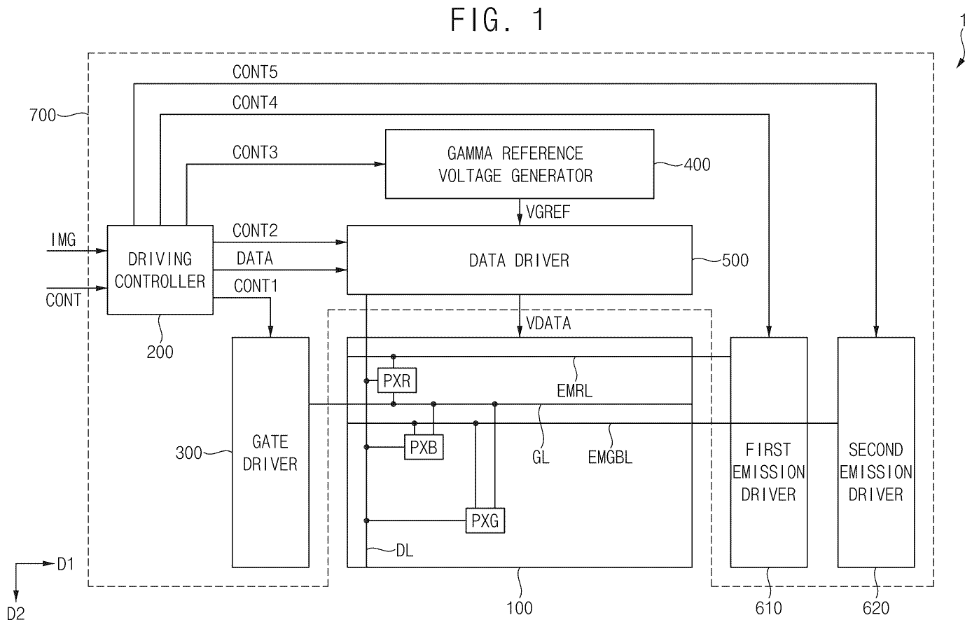

FIG. 1 is a block diagram illustrating a display device 1 according to embodiments.

Referring to FIG. 1, the display device 1 may include a display panel 100 and a display panel driver 700. The display panel driver 700 may include a driving controller 200, a gate driver 300, a gamma reference voltage generator 400, a data driver 500, a first emission driver 610, and a second emission driver 620.

For example, the driving controller 200 and the data driver 500 may be integrated into a single chip. For example, the driving controller 200, the gamma reference voltage generator 400, and the data driver 500 may be integrated into a single chip. A driving module including at least the driving controller 200 and the data driver 500 which are integrated into the single chip may be referred to as a timing controller embedded data driver (TED).

The display panel 100 may include a display region on which an image is displayed and a peripheral region adjacent to the display region. For example, the peripheral region may be referred to as a bezel.

The display panel 100 may include gate lines GL, first emission lines EMRL, second emission lines EMGBL, data lines DL, and pixels. For example, the gate lines GL may extend in a first direction D1, the first emission lines EMRL and the second emission lines EMGBL may extend in the first direction D1. The data lines DL may extend in a second direction D2 crossing the first direction D1.

The driving controller 200 may receive input image data IMG and an input control signal CONT from an external device. For example, the input image data IMG may include red image data, green image data, and blue image data. In some embodiments, the input image data IMG may further include white image data. In another example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a gate control signal CONT1, a data control signal CONT2, a gamma control signal CONT3, a first emission control signal CONT4, a second emission control signal CONT5, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical start signal and a gate clock signal.

The driving controller 200 may generate the data control signal CONT2 for controlling an operation of the data driver 500 based on the input control signal CONT, and may output the data control signal CONT2 to the data driver 500. The data control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 based on the input control signal CONT, and may output the gamma control signal CONT3 to the gamma reference voltage generator 400.

The driving controller 200 may generate the first emission control signal CONT4 for controlling an operation of the first emission driver 610 based on the input control signal CONT and may output the first emission control signal CONT4 to the first emission driver 610.

The driving controller 200 may generate the second emission control signal CONT5 for controlling an operation of the second emission driver 620 based on the input control signal CONT and may output the second emission control signal CONT5 to the second emission driver 620.

Although the first emission driver 610 and the second emission driver 620 are disposed at a first side of the display panel 100 in FIG. 1 for convenience of explanation, the present inventive concept is not limited thereto. For example, the first emission driver 610 and the second emission driver 620 are disposed at a second side of the display panel 100 which is different from the first side. For example, the first emission driver 610 is disposed at the first side of the display panel 100 and the second emission driver 620 is disposed at the second side of the display panel 100. For example, the first emission driver 610 and the second emission driver 620 may be integrally formed.

The gate driver 300 may generate gate signals transmitted to the pixels through the gate lines GL in response to the gate control signal CONT1 received from the driving controller 200. The gate driver 300 may output the gate signals to the gate lines GL. For example, the gate driver 300 may be integrated on the peripheral region of the display panel 100.

The gamma reference voltage generator 400 may generate a gamma reference voltage VGREF in response to the gamma control signal CONT3 received from the driving controller 200. The gamma reference voltage generator 400 may output the gamma reference voltage VGREF to the data driver 500.

In an embodiment, the gamma reference voltage generator 400 may be disposed in the driving controller 200, or in the data driver 500.

The data driver 500 may receive the data control signal CONT2 and the data signal DATA from the driving controller 200, and may receive the gamma reference voltages VGREF from the gamma reference voltage generator 400. The data driver 500 may convert the data signal DATA having a digital type into data voltages having an analog type using the gamma reference voltages VGREF. The data driver 500 may output the data voltages to the data lines DL.

The first emission driver 610 may generate first emission signals transmitted to the pixels through the first emission lines EMRL in response to the first emission control signal CONT4 received from the driving controller 200. The first emission driver 610 may output the first emission signals to the first emission lines EMRL.

The second emission driver 620 may generate second emission signals transmitted to the pixels through the second emission lines EMGBL in response to the second emission control signal CONT5 received from the driving controller 200. The second emission driver 620 may output the second emission signals to the second emission lines EMGBL.

In an embodiment, the display panel 100 may include a first pixel PXR which emits light of a first color, a second pixel PXB which emits light of a second color, and a third pixel PXG which emits light of a third color. For example, the first pixel PXR may emit light of a red color, the second pixel PXB may emit light of a blue color, and the third pixel PXG may emit light of a green color.

The first pixel PXR may be connected to the gate line GL, the data line DL, and the first emission lien EMRL. The second pixel PXB may be connected to the gate line GL, the data line DL, and the second emission lien EMGBL. The third pixel PXG may be connected to the gate line GL, the data line DL, and the second emission lien EMGBL. Accordingly, the first pixel PXR may receive the first emission signal, the second pixel PXB may receive the second emission signal, and the third pixel PXG may receive the second emission signal.

A first emission duty is a ratio of a period in which the first emission signal has an activation level (e.g. a low level) within a single frame. A second emission duty is a ratio of a period in which the second emission signal has an activation level (e.g. a low level) within the single frame.

The term “activation level” may refer to a level of a voltage which, when applied to a transistor described herein, may activate a transistor (e.g., turn “ON” the transistor) or deactivate a transistor (e.g., turn “OFF” the transistor) based on transistor type (e.g., P-type, N-type, or the like).

The driving controller 200 may determine the first emission duty based on an emission efficiency of the first pixel PXR. In some aspects, the driving controller 200 may determine the second emission duty based on an emission efficiency of one of the second pixel PXB and the third pixel PXG.

The driving controller 200 may determine maximum emission efficiency of the first pixel PXR within an emission efficiency determination range. The driving controller 200 may determine maximum emission efficiency of the second pixel PXB within the emission efficiency determination range. In some aspects, the driving controller 200 may determine maximum emission efficiency of the third pixel PXG within the emission efficiency determination range. The maximum emission efficiency is a maximum value of the emission efficiency of the pixel (e.g. the first pixel PXR, the second pixel PXB, and the third pixel PXG) within the emission efficiency determination range. For example, the maximum emission efficiency may be different depending on the color in which the pixel emits light. The emission efficiency determination range is a reference range for the driving controller 200 to determine the maximum emission efficiency of the pixel. For example, the emission efficiency determination range may be determined based on design specifications of the display device 1, driving voltage margin, or the like.

The driving controller 200 may determine a current density based on the maximum emission efficiency of the pixel. The current density is a driving current per unit area flowing through the pixel (e.g. a driving transistor included in the pixel).

The driving controller 200 may determine a first current density based on the maximum emission efficiency of the first pixel PXR. The maximum emission efficiency of the second pixel PXB is similar to the maximum emission efficiency of the third pixel PXG, such that the driving controller 200 may determine a second current density based on one of the maximum emission efficiency of the second pixel PXB and the maximum emission efficiency of the third pixel PXG.

In an embodiment, the maximum emission efficiency of the second pixel PXB may be greater than the maximum emission efficiency of the third pixel PXG. Accordingly, the driving controller 200 may determine the second current density based on the maximum emission efficiency of the second pixel PXB.

The driving controller 200 may determine the first emission duty based on the first current density. The driving controller 200 may determine the second emission duty based on the second current density.

The first pixel PXR may emit light based on the first emission signal having the first emission duty. The first pixel PXR may emit light with the maximum emission efficiency. The second pixel PXB may emit light based on the second emission signal having the second emission duty. The second pixel PXB may emit light with the maximum emission efficiency. In some aspects, the third pixel PXG may emit light based on the second emission signal having the second emission duty. The maximum emission efficiency of the second pixel PXB may be similar to the maximum emission efficiency of the third pixel PXG. Accordingly, the third pixel PXG may emit with emission efficiency close to the maximum emission efficiency. The first pixel PXR emits light with maximum emission efficiency, the second pixel PXB emits light with maximum emission efficiency, and the third pixel PXG emits light with the emission efficiency close to the maximum emission efficiency, such that emission efficiency of the display device 1 may be increased. The emission efficiency of the display device 1 is increased, such that power consumption of the display device 1 may be reduced.

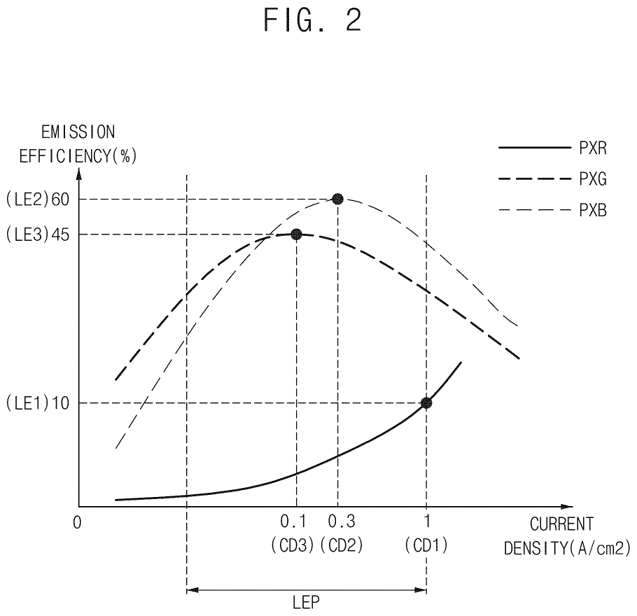

FIG. 2 is a diagram illustrating the emission efficiency % of each of the pixels included in the display panel 100 included in the display device 1 of FIG. 1.

Referring to FIG. 2, within the emission efficiency determination range LEP, the maximum emission efficiency of the first pixel PXR, the maximum emission efficiency of the second pixel PXB, and the maximum emission efficiency of the third pixel PXG may be different from each other.

Within the emission efficiency determination range LEP, the maximum emission efficiency of the first pixel PXR is first maximum efficiency LE1.

In some aspects, within the emission efficiency determination range LEP, the maximum emission efficiency of the second pixel PXB is second maximum efficiency LE2.

In some aspects, within the emission efficiency determination range LEP, the maximum emission efficiency of the third pixel PXG is third maximum efficiency LE3.

The driving controller 200 may determine the current density A/cm2 corresponding to the first maximum efficiency LE1 as the first current density CD1. In some aspects, the second maximum efficiency LE2 may be greater than the third maximum efficiency LE3. Accordingly, the driving controller 200 may determine the current density A/cm2 corresponding to the second maximum efficiency LE2 as the second current density CD2.

The driving controller 200 may determine the first emission duty based on the first current density CD1 and may control the first emission driver 610 such that the first emission driver 610 outputs the first emission signal according to the first emission duty. The driving controller 200 may determine the second emission duty based on the second current density CD2 and may control the second emission driver 620 such that the second emission driver 620 outputs the second emission signal according to the second emission duty.

In an embodiment, the first maximum efficiency LE1 may be about 10%. The current density A/cm2 corresponding to the first maximum efficiency LE1 may be about 1 A/cm2. The second maximum efficiency LE2 may be about 60%. The current density A/cm2 corresponding to the second maximum efficiency LE2 may be about 0.3 A/cm2. In some aspects, the third maximum efficiency LE3 may be about 45%. The current density A/cm2 corresponding to the third maximum efficiency LE3 may be about 0.1 A/cm2. The driving controller 200 may determine about 1 A/cm2 as the first current density CD1. In some aspects, the second maximum efficiency LE2 is greater than the third maximum efficiency LE3, such that the driving controller 200 may determine about 0.3 A/cm2 as the second current density CD2.

As the driving controller 200 determines the first emission duty based on the first current density CD1 and controls the first emission driver 610 such that the first emission driver 610 outputs the first emission signal according to the first emission duty, the first pixel PXR may emit light with the maximum emission efficiency. In some aspects, as the driving controller 200 determines the second emission duty based on the second current density CD2 and controls the second emission driver 620 such that the second emission driver 620 outputs the second emission signal according to the second emission duty, the second pixel PXB may emit light with the maximum emission efficiency. In some aspects, as the driving controller 200 determines the second emission duty based on the second current density CD2 and controls the second emission driver 620 such that the second emission driver 620 outputs the second emission signal according to the second emission duty, the third pixel PXG may emit light with the emission efficiency close to the maximum emission efficiency. The first pixel PXR emits light with maximum emission efficiency, the second pixel PXB emits light with maximum emission efficiency, and the third pixel PXG emits light with the emission efficiency close to the maximum emission efficiency, such that the emission efficiency of the display device 1 may be increased. The emission efficiency of the display device 1 is increased, such that the power consumption of the display device 1 may be reduced.

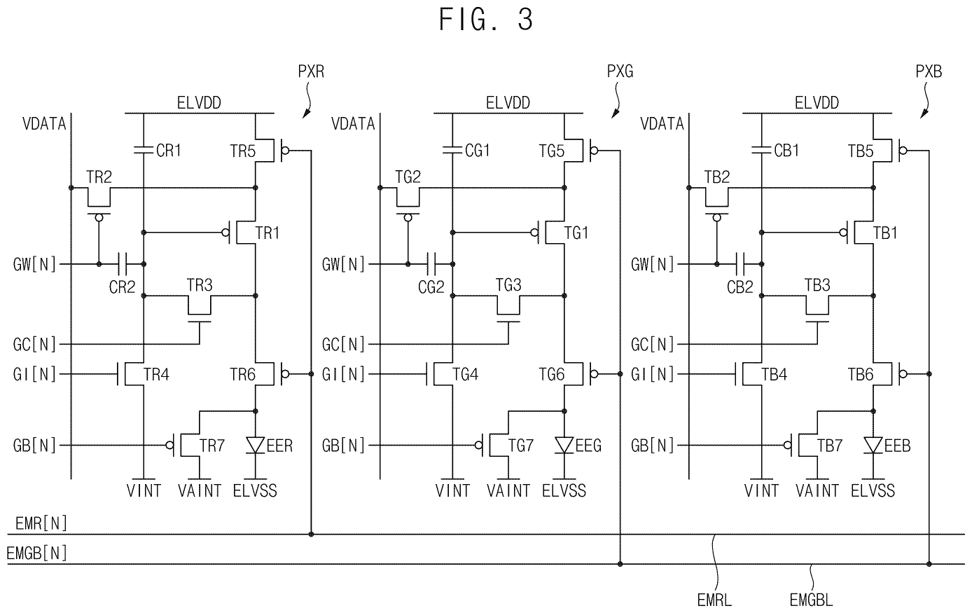

FIG. 3 is a circuit diagram illustrating an embodiment of the pixels included in the display panel 100 included in the display device 1 of FIG. 1.

Referring to FIG. 3, the display panel 100 may include the first pixel PXR which emits light of the red color, the second pixel PXB which emits light of the blue color, and the third pixel PXG which emits light of the green color. Although the display panel 100 includes the first to third pixels PXR, PXB, and PXG in FIG. 3, the display panel 100 is not limited thereto. In some aspects, although the pixel (e.g. the first to third pixels PXR, PXB, and PXG) included in the display panel 100 includes seven transistors and two capacitors in FIG. 3, the pixel is not limited thereto.

The first pixel PXR may include first-first to first-seventh transistors TR1 to TR7, a first-first capacitor CR1, a first-second capacitor CR2, and a red light emitting element EER which emits light of the red color.

The first-first transistor T1 may include a control electrode connected to a second electrode of the first-second capacitor CR2, a first electrode connected to a second electrode of the first-second transistor TR2, and a second electrode a second electrode of the first-third transistor TR3.

The first-second transistor TR2 may include a control electrode which receives a writing gate signal GW[N], a first electrode which receives the data voltage VDATA, and a second electrode connected to the first electrode of the first-first transistor TR1.

The first-third transistor TR3 may include a control electrode which receives a compensation gate signal GC[N], a first electrode connected to the control electrode of the first-first transistor TR1, and a second electrode connected to the second electrode of the first-first transistor TR1.

The first-fourth transistor TR4 may include a control electrode which receives a first initialization gate signal GI[N], a first electrode connected to the first electrode of the first-first transistor TR1, and a second electrode which receives a first initialization voltage VINT.

The first-fifth transistor TR5 may include a control electrode connected to the first emission line EMRL, a first electrode which receives a first power supply voltage ELVDD, and a second electrode connected to the first electrode of the first-first transistor TR1.

The first-sixth transistor TR6 may include a control electrode connected to the first emission line EMRL, a first electrode connected to the second electrode of the first-first transistor TR1, and a second electrode connected to an anode of the red light emitting element EER.

The control electrode of the first-fifth transistor TR5 may receive a first emission signal EMR[N] and the control electrode of the first-sixth transistor TR6 may receive the first emission signal EMR[N]. The first emission signal EMR[N] may have the first emission duty.

The first-seventh transistor TR7 may include a control electrode which receives a second initialization gate signal GB[N], a first electrode connected to the anode of the red light emitting element EER, and a second electrode which receives a second initialization voltage VAINT.

The first-first capacitor CR1 may include a first electrode which receives the first power supply voltage ELVDD and a second electrode connected to the control electrode of the first-first transistor TR1.

The first-second capacitor CR2 may include a first electrode which receives the writing gate signal GW[N] and a second electrode connected to the control electrode of the first-first transistor TR1.

The red light emitting element EER may include the anode connected to the second electrode of the first-sixth transistor TR6 and a cathode which receives a second power supply voltage ELVSS.

A P-channel metal oxide semiconductor (PMOS) transistor have a high mobility and an N-channel metal oxide semiconductor transistor may have a low leakage current. The first-first transistor TR1, the first-second transistor TR2, the first-fifth transistor TR5, the first-sixth transistor TR6, and the first-seventh transistor TR7 may be implemented as the PMOS transistors. The first-third transistor TR3 and the first-fourth transistor TR4 may be implemented as the NMOS transistors.

The second pixel PXB may include second-first to second-seventh transistors (TB1 to TB7), a second-first capacitor CB1, a second-second capacitor CB2, and a blue light emitting element EEB which emits light of the blue color.

The second-first transistor TB1 may include a control electrode connected to a second electrode of the second-second capacitor CB2, a first electrode connected to a second electrode of the second-second transistor TB2, and a second electrode connected to a second electrode of the second-third transistor TB3.

The second-second transistor TB2 may include a control electrode which receives the writing gate signal GW[N], a first electrode which receives the data voltage VDATA, and the second electrode connected to the first electrode of the second-first transistor TB1.

The second-third transistor TB3 may include a control electrode which receives the compensation gate signal GC[N], a first electrode connected to the control electrode of the second-first transistor TB1, and the second electrode connected to the second electrode of the second-first transistor TB1.

The second-fourth transistor TB4 may include a control electrode which receives the first initialization gate signal GI[N], a first electrode connected to the control electrode of the second-first transistor TB1, and a second electrode which receives the first initialization voltage VINT.

The second-fifth transistor TB5 may include a control electrode connected to the second emission lines EMGBL, a first electrode which receives the first power supply voltage ELVDD, and a second electrode connected to the first electrode of the second-first transistor TB1.

The second-sixth transistor TB6 may include a control electrode connected to the second emission lines EMGBL, a first electrode connected to the second electrode of the second-first transistor TB1, and a second electrode connected to an anode of the blue light emitting element EEB.

The control electrode of the second-fifth transistor TB5 may receive a second emission signal EMGB[N] and the control electrode of the second-sixth transistor TB6 may receive the second emission signal EMGB[N]. The second emission signal EMGB[N] may have the second emission duty.

The second-seventh transistor TB7 may include a control electrode which receives the second initialization gate signal GB[N], a first electrode connected to the anode of the blue light emitting element EEB, and a second electrode which receives the second initialization voltage VAINT.

The second-first capacitor CB1 may include a first electrode which receives the first power supply voltage ELVDD and a second electrode connected to the control electrode of the second-first transistor TB1.

The second-second capacitor CB2 may include a first electrode which receives the writing gate signal GW[N] and a second electrode connected to the control electrode of the second-first transistor TB1.

The blue light emitting element EEB may include the anode connected to the second electrode of the second-sixth transistor TB6 and a cathode which receives the second power supply voltage ELVSS.

The third pixel PXG may include third-first to third-seventh transistors TG1 to TG7, a third-first capacitor CG1, a third-second capacitor CG2, and a green light emitting element EEG.

The third-first transistor TG1 may include a control electrode connected to a second electrode of the third-second transistor TG2, a first electrode connected to a second electrode of the third-second transistor TG2, and a second electrode connected to a second electrode of the third-third transistor TG3.

The third-second transistor TG2 may include a control electrode which receives the writing gate signal GW[N], a first electrode which receives the data voltage VDATA, and the second electrode connected to the first electrode of the third-first transistor TG1.

The third-third transistor TG3 may include a control electrode which receives the compensation gate signal GC[N], a first electrode connected to the control electrode of the third-first transistor TG1, and the second electrode connected to the second electrode of the third-first transistor TG1.

The third-fourth transistor TG4 may include a control electrode which receives the first initialization gate signal GI[N], a first electrode connected to the control electrode of the third-first transistor TG1, and a second electrode which receives the first initialization voltage VINT.

The third-fifth transistor TG5 may include a control electrode connected to the second emission lines EMGBL, a first electrode which receives the first power supply voltage ELVDD, and a second electrode connected to the first electrode of the third-first transistor TG1.

The third-sixth transistor TG6 may include a control electrode connected to the second emission line EMGBL, a first electrode connected to the second electrode of the third-first transistor TG1, and a second electrode connected to an anode of the green light emitting element EEG.

The control electrode of the third-fifth transistor TG5 may receive the second emission signal EMGB[N] and the control electrode of the third-sixth transistor TG6 may receive the second emission signal EMGB[N]. The second emission signal EMGB[N] may have the second emission duty.

The third-seventh transistor TG7 may include a control electrode which receives the second initialization gate signal GB[N], a first electrode connected to the anode of the green light emitting element EEG, and a second electrode which receives the second initialization voltage VAINT.

The third-first capacitor CG1 may include a first electrode which receives the first power supply voltage ELVDD and a second electrode connected to the control electrode of the third-first transistor TG1.

The third-second capacitor CG2 may include a first electrode which receives the writing gate signal GW[N] and a second electrode connected to the control electrode of the third-first transistor TG1.

The green light emitting element EEG may include the anode connected to the second electrode of the third-sixth transistor TG6 and a cathode which receives the second power supply voltage ELVSS.

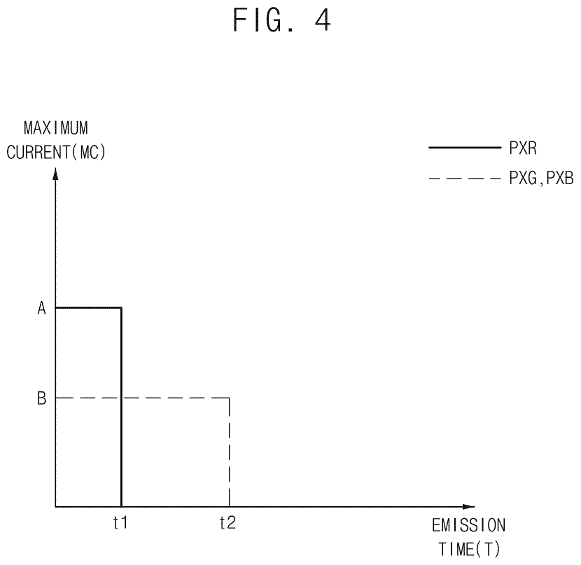

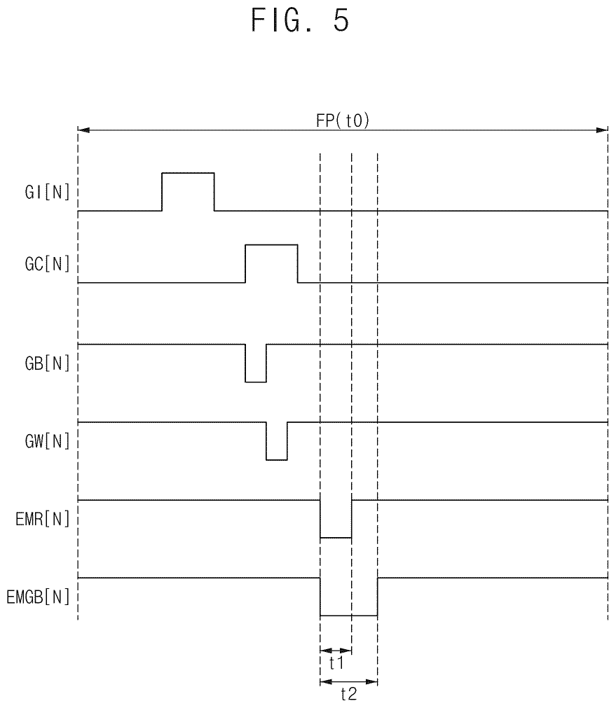

FIG. 4 is a diagram illustrating an embodiment of an emission time T and a maximum current MC of the pixels of FIG. 2. FIG. 5 is a timing diagram illustrating an operation of the pixels of FIG. 2.

Referring to FIG. 4, the emission time T is a time in which the pixels emits light. The emission time T may be proportional to the emission duty. In some aspects, the emission time T may be inversely proportional to the maximum current MC. The maximum current MC is a driving current flowing through the pixel to emit light at a maximum gray-level. That is, the maximum current MC is a maximum value of the driving current flowing through the pixel. The maximum current MC is the current density A/cm2 multiplied by the unit area cm2. Accordingly, the maximum current MC may be proportional to the current density A/cm2.

A maximum luminance is a luminance corresponding to the maximum gray-level (e.g. 255-gray-level). The maximum luminance may be calculated by [Equation 1], “ML=T*MC”, where ML denotes the maximum luminance, T denotes the emission time T, and MC denotes the maximum current MC. Accordingly, the maximum current may be inversely proportional to the emission time T.

A first maximum current A is the maximum current MC corresponding to the first current density CD1. For example, the first maximum current A may be proportional to the first current density CD1. A second maximum current B is the maximum current MC corresponding to the second current density CD2. For example, the second maximum current B may be proportional to the second current density CD2.

The driving controller 200 may determine the first current density CD1 based on the first maximum efficiency LE1. In some aspects, when the second maximum efficiency LE2 is greater than the third maximum efficiency LE3, the driving controller 200 may determine the second current density CD2 based on the second maximum efficiency LE2. The first current density CD1 may be greater than the second current density CD2.

The driving controller 200 may determine the first maximum current A based on the first current density CD1. In some aspects, the driving controller 200 may determine the second maximum current B based on the second current density CD2. The first current density CD1 is greater than the second current density CD2, such that the first maximum current A may be greater than the second maximum current B.

The driving controller 200 may determine the first emission duty based on the first current density CD1. In some aspects, the driving controller 200 may determine the second emission duty based on the second current density CD2. In an embodiment, the driving controller 200 may determine the first maximum current A based on the first current density CD1 and may determine the first emission duty based on the first maximum current A. In addition, the driving controller 200 may determine the second maximum current B based on the second current density CD2 and may determine the second emission duty based on the second maximum current B.

A first emission time t1 is a time in which the first pixel PXR emits light in the single frame FP. For example, the first emission signal EMR[N] may have the activation level during a first difference time between the first emission time t1 and zero (0). The first emission time t1 may be proportional to the first emission duty. That is, the first pixel PXR may emit light during the first emission time t1 based on the first emission signal EMR[N] having the first emission duty. A second emission time t2 is a time in which the second pixel PXB and the third pixel PXG emit light in the single frame FP. For example, the second emission signal EMGB[N] may have the activation level during a second difference time between the second emission time t2 and zero (0). The second emission time t2 may be proportional to the second emission duty. That is, the second pixel PXB and the third pixel PXG may emit light during the second emission time t2 based on the second emission signal EMGB[N] having the second emission duty.

The first maximum current A is greater than the second maximum current B, such that the first emission duty may be less than the second emission duty. Accordingly, the first emission time t1 may be shorter than the second emission time t2. That is, a length of a period, in which the first emission signal EMR[N] has an activation level in the single frame FP, may shorter than a length of a period, in which the second emission signal EMGB[N] has an activation level in the single frame FP.

Although, the driving controller 200 determines the second current density CD2, the second maximum current B, and the second emission duty based on the second maximum efficiency LE2 in FIG. 4, the present inventive concept is not limited thereto. For example, a difference between the second maximum efficiency LE2 and the third maximum efficiency LE3 is less, such that the driving controller 200 may determine the second current density CD2 based on the third maximum efficiency LE3 and may determine the second maximum current B and the second emission duty based on the second current density CD2. The third pixel PXG may emit light with the maximum emission efficiency. In some aspects, the second pixel PXB may emit light with the emission efficiency close to the maximum emission efficiency.

Referring to FIG. 5, the first pixel PXR may receive the first initialization gate signal GI[N], the compensation gate signal GC[N], the second initialization gate signal GB[N], and the writing gate signal GW[N]. The second pixel PXB may receive the first initialization gate signal GI[N], the compensation gate signal GC[N], the second initialization gate signal GB[N], and the writing gate signal GW[N]. In some aspects, the third pixel PXG may receive the first initialization gate signal GI[N], the compensation gate signal GC[N], the second initialization gate signal GB[N], and the writing gate signal GW[N].

In some aspects, the first pixel PXR may receive the first emission signal EMR[N] and the second pixel PXB may receive the second emission signal EMGB[N], and the third pixel PXG may receive the second emission signal EMGB[N].

The first emission duty may be calculated by [Equation 2], “(t1/t0)*100”, where t1 denotes the first emission time t1 and t0 denotes a total time in which the pixel operates in the single frame FP. The second emission duty may be calculated by [Equation 3], “(t2/t0)*100”, where t2 denotes the second emission time t2 and t0 denotes the total time in which the pixel operates in the single frame FP.

In an embodiment, the first pixel PXR may emit light at the maximum luminance. The second pixel PXB may emit light at the maximum luminance. In some aspects, the third pixel PXG may emit light at the maximum luminance. The emission duty of the first emission signal EMR[N] may be the first emission duty and the emission duty of the second emission signal EMGB[N] may be the second emission duty. The first emission duty may be less than the second emission duty. In some aspects, the driving current flowing through the first pixel PXR may be the first maximum current A. The driving current flowing through the second pixel PXB may be the second maximum current B. The driving current flowing through the third pixel PXG may be the second maximum current B. The first maximum current may be greater than the second maximum current B.

In an embodiment, the first pixel PXR may emit light at a first gray-level. The second pixel PXB may emit light at the first gray-level. The third pixel PXG may emit light at the first gray-level. The first gray-level may be one of gray-levels which are less than the maximum gray-level. For example, the first gray-level may be 30-gray-level. For example, the first gray-level may be 20-grya-level. The first pixel PXR may emit light at a first luminance corresponding to the first gray-level. The second pixel PXB may emit light at the first luminance corresponding to the first gray-level. In some aspects, the third pixel PXG may emit light at the first luminance corresponding to the first gray-level. The first gray-level is less than the maximum gray-level, such that the first luminance corresponding to the first gray-level may be less than the maximum luminance. The emission duty of the first emission signal EMR[N] may be the first emission duty and the emission duty of the second emission signal EMGB[N] may be the second emission duty. The first emission duty may be less than the second emission duty. In some aspects, the driving current flowing through the pixel may be determined depending on the gray-level and the luminance. The first gray-level is less than the maximum gray-level and the first luminance is less than the maximum luminance, such that the driving current flowing through the first pixel PXR may be less than the first maximum current A. The driving current flowing through the second pixel PXB may be less than the second maximum current B. In some aspects, the driving current flowing through the third pixel PXG may be less than the second maximum current B. In some aspects, the first emission duty may not be changed depending on the gray-level and the luminance. The second emission duty may not be changed depending on the gray-level and the luminance. Accordingly, the first emission duty may have a constant value regardless of the gray-level and the luminance. In some aspects, the second emission duty may have a constant value regardless of the gray-level and the luminance.

Accordingly, when the first pixel PXR emits light at the first luminance, the first emission signal EMR[N] applied to the first pixel PXR may have the first emission duty and the driving current flowing through the first pixel PXR may be less than the first maximum current A. In some aspects, the first pixel PXR may emit light during the first emission time t1. The first pixel PXR may generate up to the first maximum current A during the first emission time t1, such that the first emission time t1 may be a sufficient time to generate the driving current for the first pixel PXR to emit light at the first luminance. The first pixel PXR may generate the driving current corresponding to the first luminance during the first emission time t1, such that the first pixel PXR may accurately emit light at the first luminance.

When the second pixel PXB emits light at the first luminance, the second emission signal EMGB[N] applied to the second pixel PXB may have the second emission duty and the driving current flowing through the second pixel PXB may be less than the second maximum current B. In some aspects, the second pixel PXB may emit light during the second emission time t2. The second pixel PXB may generate up to the second maximum current B during the second emission time t2, such that the second emission time t2 may be a sufficient time to generate the driving current for the second pixel PXB to emit light at the first luminance. The second pixel PXB may generate the driving current corresponding to the first luminance during the second emission time t2, such that the second pixel PXB may accurately emit light at the first luminance.

When the third pixel PXG emits light at the first luminance, the second emission signal EMGB[N] applied to the third pixel PXG may have the second emission duty and the driving current flowing through the third pixel PXG may be less than the second maximum current B. In some aspects, the third pixel PXG may emit light during the second emission time t2. The third pixel PXG may generate up to the second maximum current B during the second emission time t2, such that the second emission time t2 may be a sufficient time to generate the driving current for the third pixel PXG to emit light at the first luminance. The third pixel PXG may generate the driving current corresponding to the first luminance during the second emission time t2, such that the third pixel PXG may accurately emit light at the first luminance.

Accordingly, the first pixel PXR, the second pixel PXB, and the third pixel PXG may accurately emit light at a target luminance for a target luminance. Accordingly, expression ability of the gray-level and expression ability of the luminance of the display device 1 may be improved.

The driving controller 200 may determine the first emission duty based on the first maximum efficiency LE1 and may determine the second emission duty based on the second maximum efficiency LE2. Accordingly, the first pixel PXR may emit light with the maximum emission efficiency, the second pixel PXB may emit light with the maximum emission efficiency, and the third pixel PXG may emit light with the emission efficiency close to the maximum emission efficiency. The first pixel PXR emits light with the maximum emission efficiency, the second pixel PXB emits light with the maximum emission efficiency, and the third pixel PXG emits light with the emission efficiency close to the maximum emission efficiency, such that the emission efficiency of the display device 1 may be increased. The emission efficiency of the display device 1 is increased, such that the power consumption of the display device 1 may be reduced.

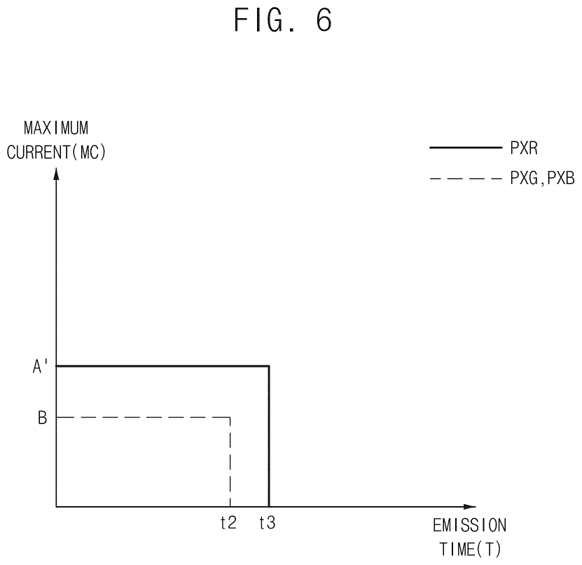

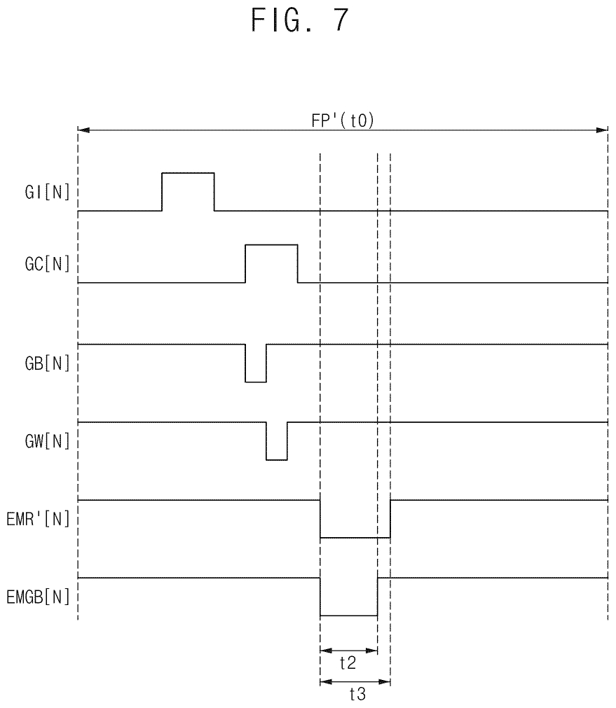

FIG. 6 is a diagram illustrating an embodiment of the emission time T and the maximum current MC of the pixel of FIG. 2. FIG. 7 is a timing diagram illustrating an operation of the pixels of FIG. 2.

Referring to FIGS. 6 and 7, the driving controller 200 may determine the first emission duty and a first maximum current A′ based on the emission efficiency of the first pixel PXR. The driving controller 200 may determine the second emission duty and the second maximum current B based on the emission efficiency of the second pixel PXB. The diagram of FIG. 6 and the timing diagram of FIG. 7 are substantially the same as the diagram of FIG. 4 and the timing diagram of FIG. 5 except for the first maximum current A', the first emission duty, and a first emission signal EMR′[N]. Thus, the same reference numerals will be used to refer to the same or like parts as those described in the previous embodiment of FIGS. 4 and 5 and any repetitive explanation concerning the above elements will be omitted.

The driving controller 200 may determine the first maximum efficiency LE1. The driving controller 200 may determine the current density A/cm2 corresponding to the first maximum efficiency LE1. In some aspects, the driving controller 200 may determine the current density A/cm2, which is less than the current density A/cm2 corresponding to the first maximum efficiency LE1, as the first current density CD1.

The driving controller 200 may determine the first maximum current A′ based on the first current density CD1. In some aspects, the driving controller 200 may determine the first emission duty based on the first current density CD1. The first maximum current A′ may be less than the first maximum current A of FIG. 4. The first maximum current A′ is less than the first maximum current A of FIG. 4, such that the first emission duty may be greater than the first emission duty of FIG. 4.

The first emission time t3 is a time in which the first pixel PXR emits light based on the first emission signal EMR′[N] having the first emission duty of FIG. 6. For example, the first emission signal EMR′[N] may have the activation level during a first difference time between the first emission time t3 and zero (0). The first emission duty is greater than the first emission duty of FIG. 4, such that the first emission time t3 may be longer than the first emission time t1 of FIG. 4.

The first emission duty may be calculated by [Equation 4], “(t3/t0)*100”, where t3 denotes the first emission time t3 and t0 denotes the total time in which the pixel operates in the single frame FP. The second emission duty may be calculated by the [Equation 3].

Although, the first emission time t3 is longer than the second emission time t2 in FIG. 6, but the present inventive concept is not limited thereto. For example, the first emission time t3 may shorter than the second emission time t2.

When the first pixel PXR emits light at the maximum luminance, stress accumulated in the first pixel PXR may be decreased by the driving controller 200 determining the first maximum current A′ to be less than the first maximum current A of FIG. 4. In an example in which the stress accumulated in the first pixel PXR is decreased, an amount of heat generated and the voltage drop (or IR drop) of the first pixel PXR may be decreased. Accordingly, stability and reliability of the first pixel PXR may be improved.

In some aspects, the second pixel PXB emits light with the maximum emission efficiency and the third pixel PXG emits light with emission efficiency close to the maximum emission efficiency, such that the emission efficiency of the display device 1 may be increased. The emission efficiency of the display device 1 is increased, such that the power consumption of the display device 1 may be reduced.

In some aspects, the driving current flowing through the pixel may be determined depending on the gray-level and the luminance. The first gray-level is less than the maximum gray-level and the first luminance is less than the maximum luminance, such that the driving current flowing through the first pixel PXR may be less than the first maximum current A′. The driving current flowing through the second pixel PXB may be less than the second maximum current B. In some aspects, the driving current flowing through the third pixel PXG may be less than the second maximum current B. In some aspects, the first emission duty may not be changed depending on the gray-level and the luminance. The second emission duty may not be changed depending on the gray-level and the luminance. That is, the first emission duty may have the constant value regardless of the gray-level and the luminance. In some aspects, the second emission duty may have the constant value regardless of the gray-level and the luminance.

Accordingly, when the first pixel PXR emits light at the first luminance, the first emission signal EMR′[N] applied to the first pixel PXR may have the first emission duty and the driving current flowing through the first pixel PXR may be less than the first maximum current A′. In some aspects, the first pixel PXR may emit light during the first emission time t3. The first pixel PXR may generate up to the first maximum current A′ during the first emission time t3, such that the first emission time t3 may be a sufficient time to generate the driving current for the first pixel PXR to emit light at the first luminance. The first pixel PXR may generate the driving current corresponding to the first luminance during the first emission time t3, such that the first pixel PXR may accurately emit light at the first luminance.

When the second pixel PXB emits light at the first luminance, the second emission signal EMGB[N] applied to the second pixel PXB may have the second emission duty and the driving current flowing through the second pixel PXB may be less than the second maximum current B. In some aspects, the second pixel PXB may emit light during the second emission time t2. The second pixel PXB may generate up to the second maximum current B during the second emission time t2, such that the second emission time t2 may be a sufficient time to generate the driving current for the second pixel PXB to emit light at the first luminance. The second pixel PXB may generate the driving current corresponding to the first luminance during the second emission time t2, such that the second pixel PXB may accurately emit light at the first luminance.

When the third pixel PXG emits light at the first luminance, the second emission signal EMGB[N] applied to the third pixel PXG may have the second emission duty and the driving current flowing through the third pixel PXG may be less than the second maximum current B. In some aspects, the third pixel PXG may emit light during the second emission time t2. The third pixel PXG may generate up to the second maximum current B during the second emission time t2, such that the second emission time t2 may be a sufficient time to generate the driving current for the third pixel PXG to emit light at the first luminance. The third pixel PXG may generate the driving current corresponding to the first luminance during the second emission time t2, such that the third pixel PXG may accurately emit light at the first luminance.

Accordingly, the first pixel PXR, the second pixel PXB, and the third pixel PXG may accurately emit light at the target luminance for the target luminance. Accordingly, the expression ability of the gray-level and the expression ability of the luminance of the display device 1 may be improved.

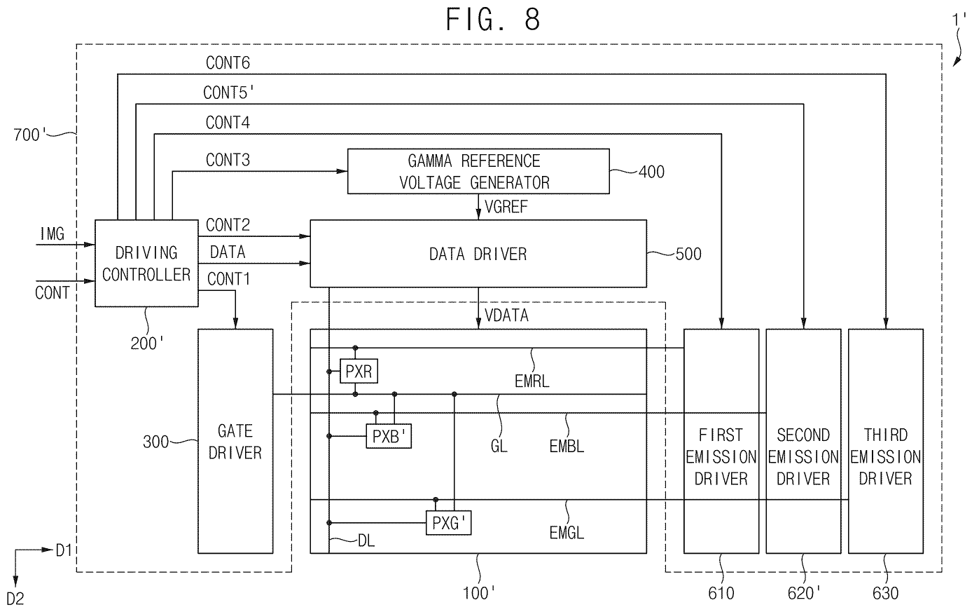

FIG. 8 is a block diagram illustrating a display device 1′ according to embodiments.

Referring to FIG. 8, the display device 1′ may include a display panel 100′ and a display panel driver 700′. The display panel driver 700′ may include the driving controller 200', the gate driver 300, the gamma reference voltage generator 400, the data driver 500, the first emission driver 610, a second emission driver 620′, and a third emission driver 630. The display device 1′ of FIG. 8 is substantially the same as the display device 1 of FIG. 1 except that the display device 1′ further includes the third emission driver 630 and the display panel 100′ further includes third emission line EMGL. Thus, the same reference numerals will be used to refer to the same or like parts as those described in the previous embodiment of FIG. 1 and any repetitive explanation concerning the above elements will be omitted.

The display panel 100 may include the gate lines GL, the first emission lines EMRL, second emission lines EMBL, third emission lines EMGL, the data lines DL, and pixels. For example, the gate lines GL may extend in the first direction D1, the first emission lines EMRL, the second emission lines EMBL, and the third emission lines EMGL may extend in the first direction D1. The data lines DL may extend in the second direction D2 crossing the first direction D1.

The driving controller 200′ may generate a second emission control signal CONT5′ for controlling an operation of the second emission driver 620′ based on the input control signal CONT and may output the second emission control signal CONT5′ to the second emission driver 620′.

The driving controller 200′ may generate a third emission control signal CONT6 for controlling an operation of the third emission driver 630 based on the input control signal CONT and may output the third emission control signal CONT6 to the third emission driver 630.

Although the first emission driver 610, the second emission driver 620′, and the third emission driver 630 are disposed at a first side of the display panel 100′ in FIG. 8 for convenience of explanation, the present inventive concept is not limited thereto. For example, the first emission driver 610, the second emission driver 620′, and the third emission driver 630 are disposed at a second side of the display panel 100′ which is different from the first side. For example, the first emission driver 610 is disposed at the first side of the display panel 100′ and the second emission driver 620′ and the third emission driver 630 are disposed at the second side of the display panel 100'. For example, the first emission driver 610, the second emission driver 620′, and the third emission driver 630 may be integrally formed.

The second emission driver 620′ may generate second emission signals transmitted to the pixels through the second emission lines EMBL in response to the second emission control signal CONT5′ received from the driving controller 200. The second emission driver 620′ may output the second emission signals to the second emission lines EMBL.

The third emission driver 630 may generate third emission signals transmitted to the pixels through the third emission lines EMGL in response to the third emission control signal CONT6 received from the driving controller 200. The third emission driver 630 may output the third emission signals to the third emission lines EMGL.

In an embodiment, the display panel 100′ may include the first pixel PXR which emits light of the first color, a second pixel PXB′ which emits light of the second color, and a third pixel PXG′ which emits light of the third color. For example, the first pixel PXR may emit light of the red color, the second pixel PXB′ may emit light of the blue color, and the third pixel PXG′ may emit light of the green color.

The first pixel PXR may be connected to the gate line GL, the data line DL, and the first emission lien EMRL. The second pixel PXB′ may be connected to the gate line GL, the data line DL, and the second emission lien EMBL. The third pixel PXG′ may be connected to the gate line GL, the data line DL, and the third emission lien EMGL. Accordingly, the first pixel PXR may receive the first emission signal, the second pixel PXB may receive the second emission signal, and the third pixel PXG may receive the third emission signal.

The first emission duty is the ratio of the period in which the first emission signal has the activation level (e.g. the low level) within the single frame. A second emission duty is a ratio of a period in which the second emission signal has an activation level (e.g. a low level) within the single frame. A third emission duty is a ratio of a period in which the third emission signal has an activation level (e.g. a low level) within the single frame. The term “emission duty” may be referred to as a “emission signal duty cycle.”

The driving controller 200′may determine the first emission duty, the second emission duty, and the third emission duty. The first emission duty, the second emission duty, and the third emission duty may be different from each other.

The driving controller 200′ may determine the first emission duty based on the emission efficiency of the first pixel PXR. The driving controller 200′ may determine the second emission duty based on an emission efficiency of the second pixel PXB′. In some aspects, the driving controller 200′ may determine the third emission duty based on an emission efficiency of the third pixel PXG′.

The driving controller 200′ may determine the first current density CD1 based on the first maximum efficiency LE1. The driving controller 200′ may determine the second current density CD2 based on the second maximum efficiency LE2. The driving controller 200′ may determine the third current density CD3 based on the third maximum efficiency LE3.

The driving controller 200′ may determine the first emission duty based on the first current duty CD1 and may control the first emission driver 610 such that the first emission driver 610 outputs the first emission signal according to the first emission duty. The driving controller 200′ may determine the second emission duty based on the second current density CD2 and may control the second emission driver 620′ such that the second emission driver 620′ outputs the second emission signal according to the second emission duty. The driving controller 200′ may determine the third emission duty based on the third current density CD3 and may control the third emission driver 630 such that the third emission driver 630 outputs the third emission signal according to the third emission duty.

The first pixel PXR may emit light based on the first emission signal having the first emission duty. The first pixel PXR may emit light with the maximum emission efficiency. The second pixel PXB′ may emit light based on the second emission signal having the second emission duty. The second pixel PXB′ may emit light with the maximum emission efficiency. The third pixel PXG′ may emit light based on the third emission signal having the third emission duty. The third pixel PXG′ may emit light with the maximum emission efficiency.

The first pixel PXR emits light with the maximum emission efficiency, the second pixel PXB′ emits light with the maximum emission efficiency, and the third pixel PXG′ emits light with the maximum emission efficiency, such that emission efficiency of the display device 1′ may be increased. The emission efficiency of the display device 1″ is increased, such that power consumption of the display device 1′ may be reduced.

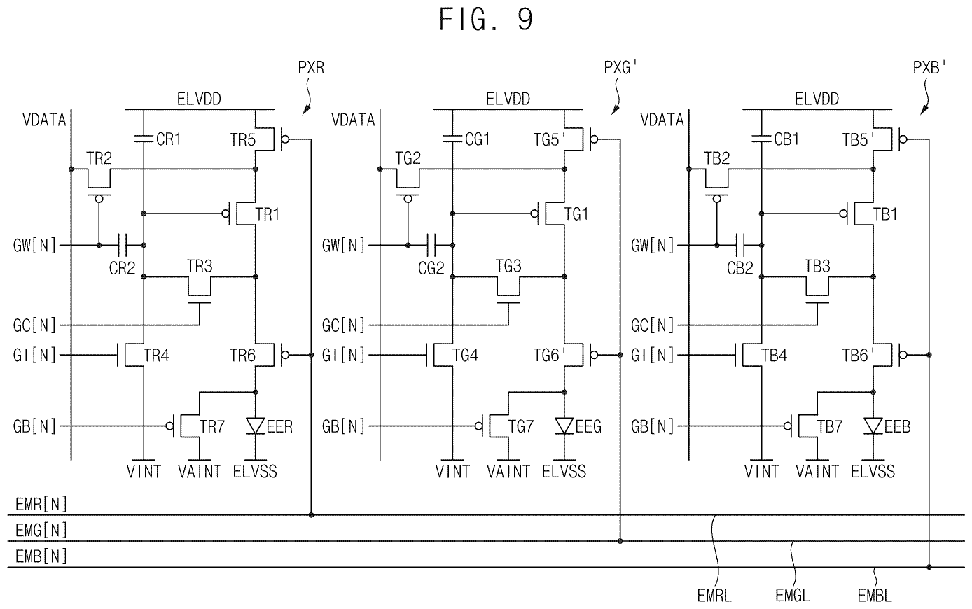

FIG. 9 is a circuit diagram illustrating the pixels included in the display panel 100′ included in the display device 1′ of FIG. 8.

Referring to FIG. 9, the display panel 100′ may include the first pixel PXR which emits light of the red color, the second pixel PXB′ which emits light of the blue color, and the third pixel PXG′ which emits light of the green color. The pixels of FIG. 9 is substantially the same as the pixels of FIG. 3 except that a control electrode of the second-fifth transistor TB5′ and a control electrode of the second-sixth transistor TB6′ are connected to the second emission line EMBL and a control electrode of the third-fifth transistor TG5′ and a control electrode of the third-sixth transistor TG6′ are connected to the third emission line EMGL. Thus, the same reference numerals will be used to refer to the same or like parts as those described in the previous embodiment of FIG. 3 and any repetitive explanation concerning the above elements will be omitted.

The control electrode of the second-fifth transistor TB5′ may be connected to the second emission line EMBL. The control electrode of the second-sixth transistor TB6′ may be connected to the second emission line EMBL. That is, the control electrode of the second-fifth transistor TB5′ may receive the second emission signal EMB[N] and the second-sixth transistor TB6′ may receive the second emission signal EMB[N]. The second emission signal EMB[N] may have the second emission duty.

The control electrode of the third-fifth transistor TG5′ and the control electrode of the third-sixth transistor TG6′ may be connected to the third emission line EMGL. That is, the control electrode of the third-fifth transistor TG5′ may receive the third emission signal EMG[N] and the control electrode of the third-sixth transistor TG6′ may receive the third emission signal EMG[N]. The third emission signal EMG[N] may have the third emission duty.

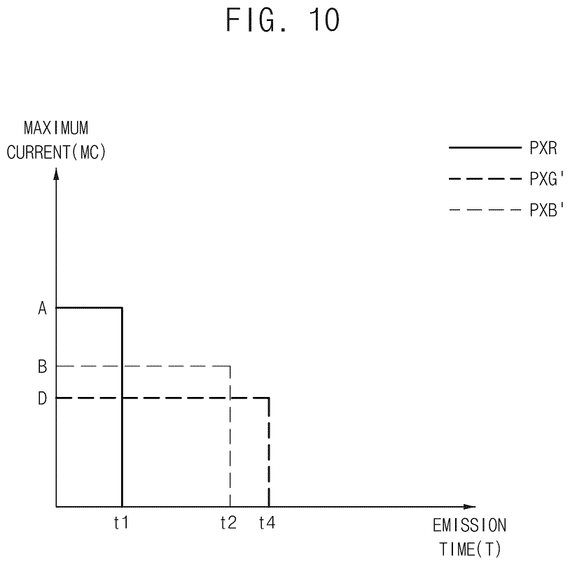

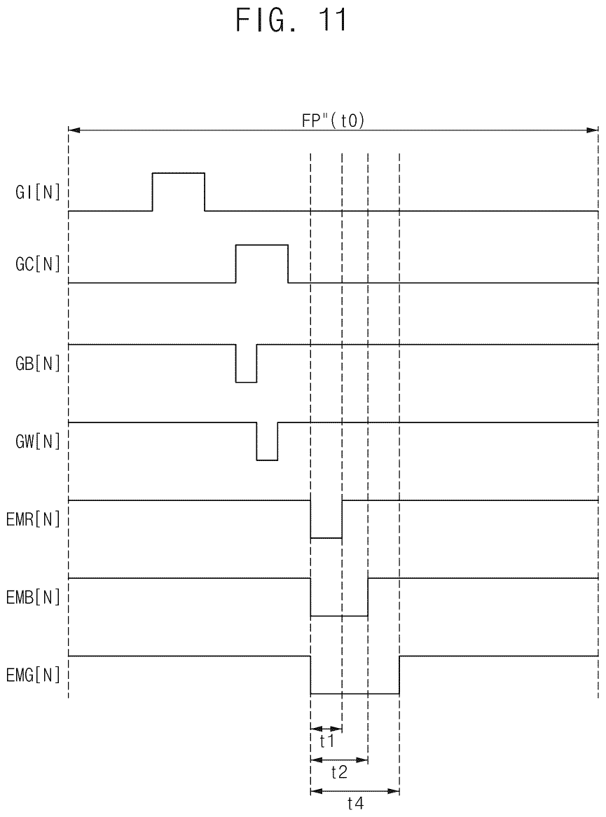

FIG. 10 is a diagram illustrating an embodiment of an emission time T and a maximum current MC of the pixels of FIG. 9. FIG. 11 is a timing diagram illustrating an operation of the pixels of FIG. 9.

Referring to FIG. 10, the emission time T is a time in which the pixels emits light. The emission time T may be proportional to the emission duty. In some aspects, the emission time T may be inversely proportional to the maximum current MC. The maximum current MC is the maximum value of the driving current flowing through the pixel. The maximum current MC is the current density A/cm2 multiplied by the unit area cm2. Accordingly, the maximum current MC may be proportional to the current density A/cm2.

The maximum luminance is the luminance corresponding to the maximum gray-level (e.g. 255-gray-level). The maximum luminance may be calculated by [Equation 1], “ML=T*MC”, where ML denotes the maximum luminance, T denotes the emission time T, and MC denotes the maximum current MC. Accordingly, the maximum current may be inversely proportional to the emission time T.

The diagram of FIG. 10 and the timing diagram of FIG. 11 are substantially the same as the diagram of FIG. 4 and the timing diagram of FIG. 5 except that the third emission signal EMG[n] is applied to the third pixel PXG′. Thus, the same reference numerals will be used to refer to the same or like parts as those described in the previous embodiment of FIGS. 4 and 5 and any repetitive explanation concerning the above elements will be omitted.

The first maximum current A is the maximum current MC corresponding to the first current density CD1. For example, the first maximum current A may be proportional to the first current density CD1. The second maximum current B is the maximum current MC corresponding to the second current density CD2. For example, the second maximum current B may be proportional to the second current density CD2. A third maximum current D is the maximum current MC corresponding to the third current density CD3. For example, the third maximum current D may be proportional to the third current density CD3.

The driving controller 200′ may determine the first current density CD1 based on the first maximum efficiency LE1. The driving controller 200′ may determine the second current density CD2 based on the second maximum efficiency LE2. In some aspects, the driving controller 200′ may determine the third current density CD3 based on the third maximum efficiency LE3. The first current density CD1 may be greater than the second current density CD2 and the second current density CD2 may be greater than the third current density CD3.

The driving controller 200′ may determine the first maximum current A based on the first current density CD1. The driving controller 200′ may determine the second maximum current B based on the second current density CD2. In some aspects, the driving controller 200′ may determine the third maximum current D based on the third current density CD3. The first current density CD1 is greater than the second current density CD2, such that the first maximum current A may be greater than the second maximum current B. In some aspects, the second current density CD2 is greater than the third current density CD3, such that the second maximum current B may be greater than the third maximum current D.

The driving controller 200′ may determine the first emission duty based on the first current density CD1. The driving controller 200′ may determine the second emission duty based on the second current density CD2. In some aspects, the driving controller 200′ may determine the third emission duty based on the third current density CD3. In an embodiment, the driving controller 200′ may determine the first maximum current A based on the first current density CD1 and may determine the first emission duty based on the first maximum current A. In addition, the driving controller 200′ may determine the second maximum current B based on the second current density CD2 and may determine the second emission duty based on the second maximum current B. In addition, the driving controller 200′ may determine the third maximum current D based on the third current density CD3 and may determine the third emission duty based on the third maximum current D.

A first emission time t1 is a time in which the first pixel PXR emits light in the single frame FP″. For example, the first emission signal EMR[N] may have the activation level during the first difference time between the first emission time t1 and zero (0). The first emission time t1 may be proportional to the first emission duty. That is, the first pixel PXR may emit light during the first emission time t1 based on the first emission signal EMR[N] having the first emission duty.

A second emission time t2 is a time in which the second pixel PXB′ emits light in the single frame FP″. For example, the second emission signal EMB[N] may have the activation level during the second difference time between the second emission time t2 and zero (0). The second emission time t2 may be proportional to the second emission duty. That is, the second pixel PXB′ may emit light during the second emission time t2 based on the second emission signal EMB[N] having the second emission duty.

A third emission time t4 is a time in which the second pixel PXG′ emits light in the single frame FP″. For example, the third emission signal EMG[N] may have the activation level during a third difference time between the third emission time t4 and zero (0). The third emission time t4 may be proportional to the third emission duty. That is, the second pixel PXG′ may emit light during the third emission time t4 based on the third emission signal EMG[N] having the third emission duty.

The first maximum current A is greater than the second maximum current B, such that the first emission duty may be less than the second emission duty. Accordingly, the first emission time t1 may be shorter than the second emission time t2. That is, a length of a period, in which the first emission signal EMR[N] has the activation level in the single frame FP″, may shorter than a length of a period, in which the second emission signal EMB[N] has the activation level.

In some aspects, the second maximum current B is greater than the third maximum current D, such that the second emission duty may be less than the third emission duty. Accordingly, the second emission time t2 may be shorter than the third emission time t4. That is, the length of the period, in which the second emission signal EMB[N] has the activation level in the single frame FP″, may shorter than a length of a period, in which the third emission signal EMG[N] has the activation level.

Referring to FIG. 11, the first pixel PXR may receive the first emission signal EMR[N], the second pixel PXB′ may receive the second emission signal EMB[N], and the third pixel PXG′ may receive the third emission signal EMG[N].

The first emission duty may be calculated by the [Equation 2], “(t1/t0)*100”, where t1 denotes the first emission time t1 and t0 denotes a total time in which the pixel operates in the single frame FP″. The second emission duty may be calculated by the [Equation 3], “(t2/t0)*100”, where t2 denotes the second emission time t2 and t0 denotes the total time in which the pixel operates in the single frame FP″. The third emission duty may be calculated by [Equation 5], “(t4/t0)*100”, where t 4 denotes the third emission time t4 and t0 denotes the total time in which the pixel operates in the single frame FP″.

In an embodiment, the first pixel PXR may emit light at the maximum luminance. The second pixel PXB may emit light at the maximum luminance. In some aspects, the third pixel PXG′ may emit light at the maximum luminance. The emission duty of the first emission signal EMR[N] may be the first emission duty, the emission duty of the second emission signal EMB[N] may be the second emission duty, and the emission duty of the third emission signal EMG[N] may be the third emission duty. The first emission duty may be less than the second emission duty and the second emission duty may be less than the third emission duty. In some aspects, the driving current flowing through the first pixel PXR may be the first maximum current A, the driving current flowing through the second pixel PXB′ may be the second maximum current B, and the driving current flowing through the third pixel PXG′ may be the third maximum current D. The driving current flowing through the third pixel PXG may be the second maximum current B. The first maximum current may be greater than the second maximum current B and the second maximum current B may be greater than the third maximum current D.

In an embodiment, the first pixel PXR may emit light at the first gray-level. The second pixel PXB′ may emit light at the first gray-level. The third pixel PXG′ may emit light at the first gray-level. The first gray-level may be one of the gray-levels which are less than the maximum gray-level. For example, the first gray-level may be the 30-gray-level. For example, the first gray-level may be the 20-grya-level. The first pixel PXR may emit light at the first luminance corresponding to the first gray-level. The second pixel PXB′ may emit light at the first luminance corresponding to the first gray-level. In some aspects, the third pixel PXG′ may emit light at the first luminance corresponding to the first gray-level. The first gray-level is less than the maximum gray-level, such that the first luminance corresponding to the first gray-level may be less than the maximum luminance. The emission duty of the first emission signal EMR[N] may be the first emission duty, the emission duty of the second emission signal EMB[N] may be the second emission duty, and the emission duty of the third emission signal EMG[N] may be the third emission duty. The first emission duty may be less than the second emission duty and the second emission duty may be less than the third emission duty. In some aspects, the driving current flowing through the pixel may be determined depending on the gray-level and the luminance. The first gray-level is less than the maximum gray-level and the first luminance is less than the maximum luminance, such that the driving current flowing through the first pixel PXR may be less than the first maximum current A. The driving current flowing through the second pixel PXB′ may be less than the second maximum current B. In some aspects, the driving current flowing through the third pixel PXG′ may be less than the third maximum current D. In some aspects, the first emission duty may not be changed depending on the gray-level and the luminance. The second emission duty may not be changed depending on the gray-level and the luminance. In some aspects, the third emission duty may not be changed depending on the gray-level and the luminance. Accordingly, the first emission duty may have the constant value regardless of the gray-level and the luminance. The second emission duty may have the constant value regardless of the gray-level and the luminance. In some aspects, the third emission duty may have a constant value regardless of the gray-level and the luminance.

Accordingly, when the first pixel PXR emits light at the first luminance, the first emission signal EMR[N] applied to the first pixel PXR may have the first emission duty and the driving current flowing through the first pixel PXR may be less than the first maximum current A. In some aspects, the first pixel PXR may emit light during the first emission time t1. The first pixel PXR may generate up to the first maximum current A during the first emission time t1, such that the first emission time t1 may be the sufficient time to generate the driving current for the first pixel PXR to emit light at the first luminance. The first pixel PXR may generate the driving current corresponding to the first luminance during the first emission time t1, such that the first pixel PXR may accurately emit light at the first luminance.

When the second pixel PXB′ emits light at the first luminance, the second emission signal EMB[N] applied to the second pixel PXB′ may have the second emission duty and the driving current flowing through the second pixel PXB′ may be less than the second maximum current B. In some aspects, the second pixel PXB′ may emit light during the second emission time t2. The second pixel PXB may generate up to the second maximum current B during the second emission time t2, such that the second emission time t2 may be the sufficient time to generate the driving current for the second pixel PXB′ to emit light at the first luminance. The second pixel PXB′ may generate the driving current corresponding to the first luminance during the second emission time t2, such that the second pixel PXB′ may accurately emit light at the first luminance.

When the third pixel PXG′ emits light at the first luminance, the third emission signal EMG[N] applied to the third pixel PXG′ may have the third emission duty and the driving current flowing through the third pixel PXG′ may be less than the third maximum current D. In some aspects, the third pixel PXG′ may emit light during the third emission time t4. The third pixel PXG′ may generate up to the third maximum current D during the third emission time t4, such that the third emission time t4 may be a sufficient time to generate the driving current for the third pixel PXG′ to emit light at the first luminance. The third pixel PXG′ may generate the driving current corresponding to the first luminance during the third emission time t4, such that the third pixel PXG′ may accurately emit light at the first luminance.

Accordingly, the first pixel PXR, the second pixel PXB′, and the third pixel PXG′ may accurately emit light at the target luminance for the target luminance. Accordingly, the expression ability of the gray-level and the expression ability of the luminance of the display device 1′ may be improved.

In some aspects, the driving controller 200′ may determine the first emission duty based on the first maximum efficiency LE1, may determine the second emission duty based on the second maximum efficiency LE2, and may determine the third emission duty based on the third maximum efficiency LE3. Accordingly, the first pixel PXR may emit light with the maximum emission efficiency, the second pixel PXB′ may emit light with the maximum emission efficiency, and the third pixel PXG′ may emit light with the maximum emission efficiency. The first pixel PXR emits light with the maximum emission efficiency, the second pixel PXB emits light with the maximum emission efficiency, and the third pixel PXG emits light with the maximum emission efficiency, such that the emission efficiency of the display device 1′ may be increased. The emission efficiency of the display device 1′ is increased, such that the power consumption of the display device 1′ may be reduced.

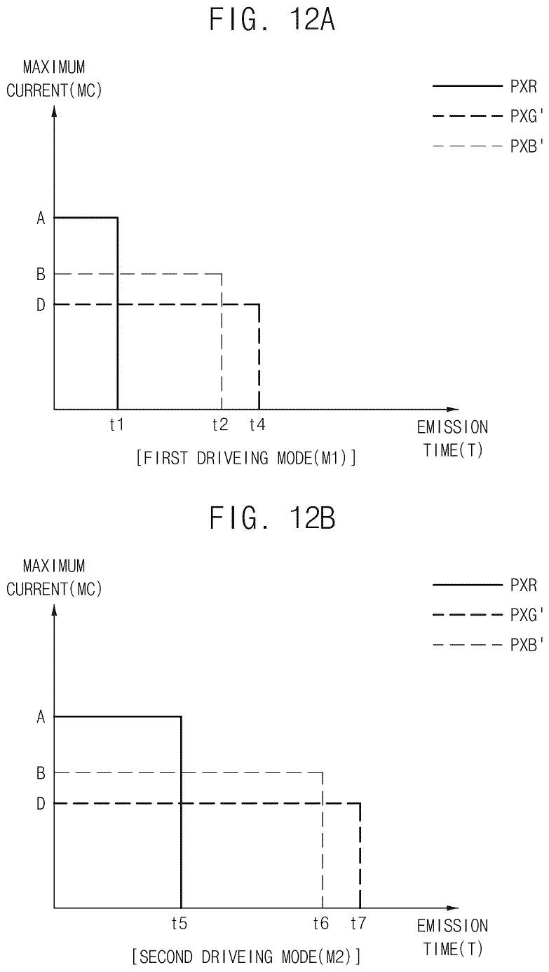

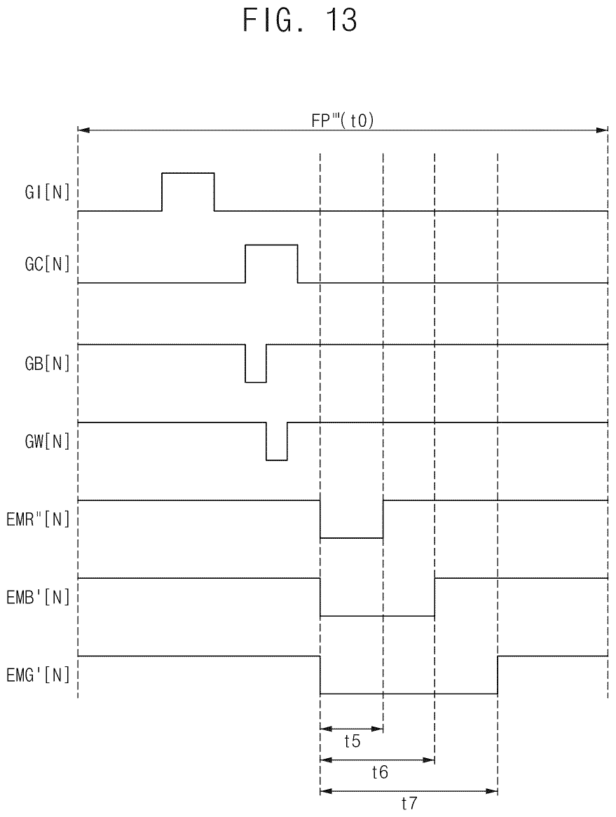

FIG. 12A is a diagram illustrating an embodiment of the emission time T and the maximum current MC of the pixels of FIG. 9 according to a first driving mode M1 of the display device 1′ of FIG. 8. FIG. 12B is a diagram illustrating an embodiment of the emission time T and the maximum current MC of the pixels of FIG. 9 according to a second driving mode M2 of the display device 1′ of FIG. 8. FIG. 13 is a timing diagram illustrating an operation of the pixels of FIG. 9 in the second driving mode M2 of FIG. 12A.

Referring to FIGS. 12A and 12B, a driving mode of the display device 1′ may include the first driving mode M1, in which the maximum luminance for the maximum gray-level is a first maximum luminance, and the second driving mode M2, in which the maximum luminance for the maximum gray-level is a second maximum luminance higher than the first maximum luminance. For example, the display device 1′ may emit at about 600 nits for 255-gray-level in the first driving mode M1 and the display device 1′ may emit at about 1200 nits for the 255-gray-level in the second driving mode M2. The first driving mode M1 may be a normal mode and the second driving mode may be a high-luminance mode.

An operation of the display device 1′ in the first driving mode M1 may be identical to an operation of the display device 1′ described in FIG. 10. Accordingly, descriptions for the first driving mode M1 will be omitted.

The emission efficiency % of the pixel is determined during the design process of the pixel, such that the emission efficiency % of the first pixel PXR of the first driving mode M1 may be the same as the emission efficiency % of the first pixel PXR of the second driving mode M2. The emission efficiency % of the second pixel PXB′ of the first driving mode M1 may be the same as the emission efficiency % of the second pixel PXB′ of the second driving mode M2. In some aspects, the emission efficiency % of the third pixel PXG′ of the first driving mode M1 may be the same as the emission efficiency % of the third pixel PXG′ of the second driving mode M2. Accordingly, the first maximum efficiency LE1 of the first driving mode M1 may be the same as the first maximum efficiency LE1 of the second driving mode M2. The second maximum efficiency LE2 of the first driving mode M1 may be the same as the second maximum efficiency LE2 of the second driving mode M2. In some aspects, the third maximum efficiency LE3 of the first driving mode M1 may be the same as the third maximum efficiency LE3 of the second driving mode M2.

In some aspects, the first maximum efficiency LE1 of the first driving mode M1 is identical to the first maximum efficiency LE1 of the second driving mode M2, such that the first current density CD1 of the first driving mode M1 may be identical to the first current density CD1 of the second driving mode M2. The second maximum efficiency LE2 of the first driving mode M1 is identical to the second maximum efficiency LE2 of the second driving mode M2, such that the second current density CD2 of the first driving mode M1 may be identical to the second current density CD2 of the second driving mode M2. In some aspects, the third maximum efficiency LE3 of the first driving mode M1 is identical to the third maximum efficiency LE3 of the second driving mode M2, such that the third current density CD3 of the first driving mode M1 may be identical to the third current density CD3 of the second driving mode M2.

In some aspects, the first current density CD1 of the first driving mode M1 is identical to the first current density CD1 of the second driving mode M2, such that the first maximum current A of the first driving mode M1 may be identical to the first maximum current A of the second driving mode M2. The second current density CD2 of the first driving mode M1 is identical to the second current density CD2 of the second driving mode M2, such that the second maximum current B of the first driving mode M1 may be identical to the second maximum current B of the second driving mode M2. In some aspects, the third current density CD3 of the first driving mode M1 is identical to the third current density CD3 of the second driving mode M2, such that the third maximum current D of the first driving mode M1 may be identical to the third maximum current D of the second driving mode M2.

A fourth emission duty is a ratio of a period in which the first emission signal EMR′[N] has the activation level (e.g. the low level) within a single frame FP′″ of the second driving mode M2. A fifth emission duty is a ratio of a period in which the second emission signal EMB′[N] has the activation level (e.g. the low level) within a single frame FP′″ of the second driving mode M2. A sixth emission duty is a ratio of a period in which the third emission signal EMG′[N] has the activation level (e.g. the low level) within a single frame FP′″ of the second driving mode M2.

A fourth emission time t5 is a time in which the first pixel PXR emits light in the single frame FP′″ of the second driving mode M2. For example, the first emission signal EMR′[N] may have the activation level during a fourth difference time between the fourth emission time t5 and zero (0). The fourth emission time t5 may be proportional to the fourth emission duty. That is, the first pixel PXR may emit light during the fourth emission time t5 based on the first emission signal EMR′[N] having the fourth emission duty. A fifth emission time t6 is a time in which the second pixel PXB′ emits light in the single frame FP′″ of the second driving mode M2. For example, the second emission signal EMB′[N] may have the activation level during a fifth difference time between the fifth emission time t6 and zero (0). The fifth emission time t6 may be proportional to the fifth emission duty. That is, the second pixel PXB′ may emit light during the fifth emission time t6 based on the second emission signal EMB′[N] having the fifth emission duty. A sixth emission time t7 is a time in which the third pixel PXG′ emits light in the single frame FP′″ of the second driving mode M2. For example, the third emission signal EMG′[N] may have the activation level during a sixth difference time between the sixth emission time t7 and zero (0). The sixth emission time t7 may be proportional to the sixth emission duty. That is, the third pixel PXG′ may emit light during the sixth emission time t7 based on the third emission signal EMG′[N] having the sixth emission duty.

The maximum luminance is the luminance corresponding to the maximum gray-level (e.g. the 255-gray-level). The maximum luminance may be calculated by [Equation 1], “ML=T*MC”, where ML denotes the maximum luminance, T denotes the emission time T, and MC denotes the maximum current MC. Accordingly, when the maximum current MC is the same, the maximum luminance may be proportional to the emission time T. Accordingly, the first maximum current A of the first driving mode M1 is identical to the first maximum current A of the second driving mode M2, the second maximum luminance is greater than the first maximum luminance, such that the fourth emission duty may be greater than the first emission duty. Accordingly, the fourth emission time t5 may be longer than the first emission time t1. In some aspects, the second maximum current B of the first driving mode M1 is identical to the second maximum current B of the second driving mode M2, the second maximum luminance is greater than the first maximum luminance, such that the fifth emission duty may be greater than the second emission duty. Accordingly, the fifth emission time t6 may be longer than the second emission time t2. In some aspects, the third maximum current D of the first driving mode M1 is identical to the third maximum current D of the second driving mode M2, the second maximum luminance is greater than the first maximum luminance, such that the sixth emission duty may be greater than the third emission duty. Accordingly, the sixth emission time t7 may be longer than the third emission time t4.

The first maximum current A may be greater than the second maximum current B. Accordingly, the fourth emission duty may be less than the fifth emission duty. Accordingly, the fourth emission time t5 may be shorter than the fifth emission time t6. The second maximum current B may be greater than the third maximum current D. Accordingly, the fifth emission duty may be less than the sixth emission duty. Accordingly, the fifth emission time t6 may be shorter than the sixth emission time t7.

Referring to FIG. 13, the first pixel PXR may receive the first initialization gate signal GI[N], the compensation gate signal GC[N], the second initialization gate signal GB[N], and the writing gate signal GW[N] in the second driving mode M2. The second pixel PXB′ may receive the first initialization gate signal GI[N], the compensation gate signal GC[N], the second initialization gate signal GB[N], and the writing gate signal GW[N] in the second driving mode M2. In some aspects, the third pixel PXG′ may receive the first initialization gate signal GI[N], the compensation gate signal GC[N], the second initialization gate signal GB[N], and the writing gate signal GW[N] in the second driving mode M2.

In some aspects, in the second driving mode M2, the first pixel PXR may receive the first emission signal EMR′[N], the second pixel PXB′ may receive the second emission signal EMB′[N], and the third pixel PXG′ may receive the third emission signal EMG′[N].

The fourth emission duty may be calculated [Equation 6], “(t5/t0)*100”, where t5 denotes the fourth emission time t5 and t0 denotes the total time in which the pixel operates in the single frame FP″′. The fifth emission duty may be calculated [Equation 7], “(t6/t0)*100”, where t6 denotes the fifth emission time t6 and t0 denotes the total time in which the pixel operates in the single frame FP′″. The sixth emission duty may be calculated [Equation 8], “(t7/t0)*100”, where t7 denotes the sixth emission time t7 and t0 denotes the total time in which the pixel operates in the single frame FP′″.

In an embodiment, the first pixel PXR may emit light at the second maximum luminance in the second driving mode M2. The second pixel PXB′ may emit light at the second maximum luminance in the second driving mode M2. In some aspects, the third pixel PXG′ may emit light at the second maximum luminance in the second driving mode M2. The emission duty of the first emission signal EMR′[N] may be the fourth emission duty, the emission duty of the second emission signal EMB′[N] may be the fifth emission duty, and the emission duty of the third emission signal EMG′[N] may be the sixth emission duty. The fourth emission duty may be less than the fifth emission duty and the fifth emission duty may be less than the sixth emission duty. In some aspects, the driving current flowing through the first pixel PXR may be the first maximum current A, the driving current flowing through the second pixel PXB′ may be the second maximum current B, and the driving current flowing through the third pixel PXG′ may be the third maximum current D. The first maximum current A may be greater than the second maximum current B and the second maximum current B may be greater than the third maximum current D.

In an embodiment, in the first driving mode M1, the first pixel PXR may emit light at the first gray-level, the second pixel PXB′ may emit light at the first gray-level, and the third pixel may emit light at the first gray-level. The first gray-level may be one of the gray-levels which are less than the maximum gray-level. For example, the first gray-level may be the 30-gray-level. For example, the first gray-level may be the 20-grya-level. The first pixel PXR may emit light at the first luminance corresponding to the first gray-level. The second pixel PXB′ may emit light at the first luminance corresponding to the first gray-level. In some aspects, the third pixel PXG′ may emit light at the first luminance corresponding to the first gray-level.

In the second driving mode M2, the first pixel PXR may emit light at the first gray-level, the second pixel PXB′ may emit light at the first gray-level, and the third pixel may emit light at the first gray-level. The first gray-level may be one of the gray-levels which are less than the maximum gray-level. The first pixel PXR may emit light at a second luminance corresponding to the first gray-level. The second pixel PXB′ may emit light at the second luminance corresponding to the first gray-level. In some aspects, the third pixel PXG′ may emit light at the second luminance corresponding to the first gray-level. The second luminance may be higher than the first luminance. In the second driving mode M2, the first gray-level is less than the maximum gray-level, such that the second luminance corresponding to the first gray-level may be less than the second maximum luminance. The emission duty of the first emission signal EMR′[N] may be the fourth emission duty, the emission duty of the second emission signal EMB′[N] may be the fifth emission duty, and the emission duty of the third emission signal EMG′[N] may be the sixth emission duty. The fourth emission duty may be less than the fifth emission duty and the fifth emission duty may be less than the sixth emission duty. In some aspects, the driving current flowing through the pixel may be determined depending on the gray-level and the luminance. The first gray-level is less than the maximum gray-level and the second luminance is less than the second maximum luminance, such that the driving current flowing through the first pixel PXR may be less than the first maximum current A. The first gray-level is less than the maximum gray-level and the second luminance is less than the second maximum luminance, such that the driving current flowing through the second pixel PXB′ may be less than the second maximum current B. The first gray-level is less than the maximum gray-level and the second luminance is less than the second maximum luminance, such that the driving current flowing through the third pixel PXG′ may be less than the third maximum current D. In some aspects, the fourth emission duty may not be changed depending on the gray-level and the luminance, the fifth emission duty may not be changed depending on the gray-level and the luminance, and the sixth emission duty may not be changed depending on the gray-level and the luminance. That is, the fourth emission duty may have the constant value regardless of the gray-level and the luminance, the fifth emission duty may have the constant value regardless of the gray-level and the luminance, and the sixth emission duty may have the constant value regardless of the gray-level and the luminance.

Accordingly, when the first pixel PXR emit light at the second luminance in the second driving mode M2, the first emission signal EMR′[N] may have the fourth emission duty and the driving current flowing through the first pixel PXR may be less than the first maximum current A. In some aspects, the first pixel PXR may emit light during the fourth emission time t5. The first pixel PXR may generate up to the first maximum current A during the fourth emission time t5, such that the fourth emission time t5 may be the sufficient time to generate the driving current for the first pixel PXR to emit light at the second luminance. The first pixel PXR may generate the driving current corresponding to the second luminance during the fourth emission time t5, such that the first pixel PXR may accurately emit light at the second luminance.

When the second pixel PXB′ emit light at the second luminance in the second driving mode M2, the second emission signal EMB′[N] may have the fifth emission duty and the driving current flowing through the second pixel PXB′ may be less than the second maximum current B. In some aspects, the second pixel PXB′ may emit light during the fifth emission time t6. The second pixel PXB′ may generate up to the second maximum current B during the fifth emission time t6, such that the fifth emission time t6 may be the sufficient time to generate the driving current for the second pixel PXB′ to emit light at the second luminance. The second pixel PXB′ may generate the driving current corresponding to the second luminance during the fifth emission time t6, such that the second pixel PXB′ may accurately emit light at the second luminance.

In some aspects, when the third pixel PXG′ emit light at the second luminance in the second driving mode M2, the third emission signal EMG′[N] may have the sixth emission duty and the driving current flowing through the third pixel PXG′ may be less than the third maximum current D. In some aspects, the third pixel PXG′ may emit light during the sixth emission time t7. The third pixel PXG′ may generate up to the third maximum current D during the sixth emission time t7, such that the sixth emission time t7 may be the sufficient time to generate the driving current for the third pixel PXG′ to emit light at the second luminance. The third pixel PXG′ may generate the driving current corresponding to the second luminance during the sixth emission time t7, such that the third pixel PXG′ may accurately emit light at the second luminance.

Accordingly, the first pixel PXR, the second pixel PXB′, and the third pixel PXG′ may accurately emit light at the target luminance for the target luminance. Accordingly, the expression ability of the gray-level and the expression ability of the luminance of the display device 1′ may be improved.

In some aspects, in the first driving mode M1, as the driving controller 200′ determines the first emission duty based on the first maximum efficiency LE1, determines the second emission duty based on the second maximum efficiency LE2, and determines the third emission duty based on the third maximum efficiency LE3, the first pixel PXR may emit light with the maximum emission efficiency, the second pixel PXB′ may emit light with the maximum emission efficiency, and the third pixel PXG′ may emit light with the maximum emission efficiency.

In some aspects, in the second driving mode M2, as the driving controller 200′ determines the fourth emission duty based on the first maximum efficiency LE1, determines the fifth emission duty based on the second maximum efficiency LE2, and determines the sixth emission duty based on the third maximum efficiency LE3, the first pixel PXR may emit light with the maximum emission efficiency, the second pixel PXB′ may emit light with the maximum emission efficiency, and the third pixel PXG′ may emit light with the maximum emission efficiency.

The first pixel PXR emits light with the maximum emission efficiency, the second pixel PXB′ emits light with the maximum emission efficiency, and the third pixel PXG′ emits light with the maximum emission efficiency, such that the emission efficiency of the display device 1′ may be increased. The emission efficiency of the display device 1′ is increased, such that the power consumption of the display device 1′ may be reduced.

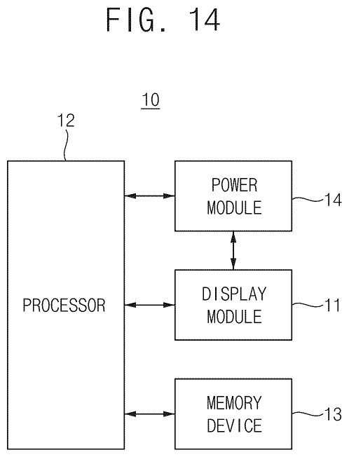

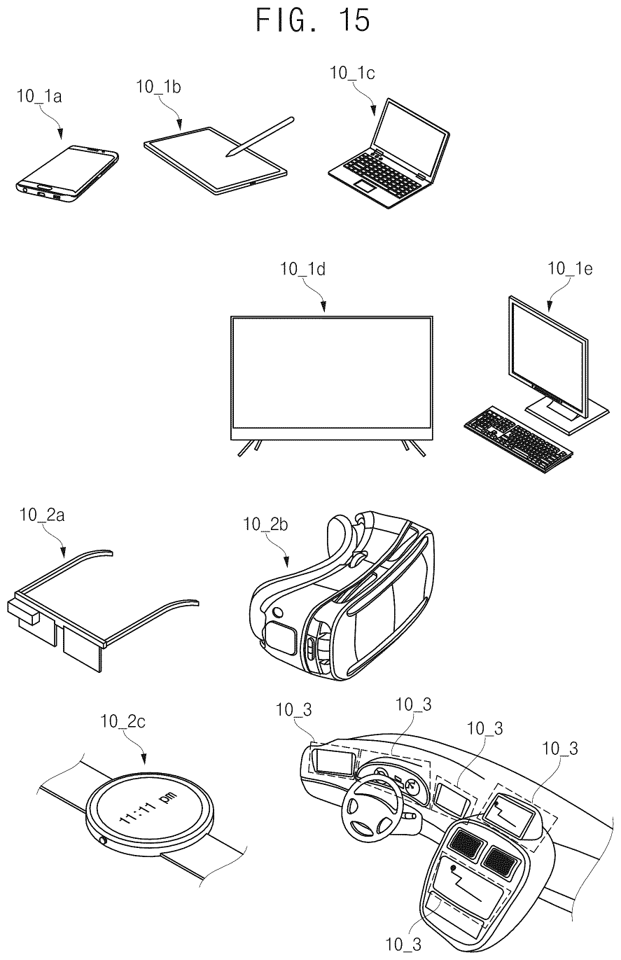

FIG. 14 is a block diagram illustrating an electronic device 10 according to embodiments. FIG. 15 is a schematic diagram illustrating the electronic device 10 of FIG. 14 according to embodiments.

Referring to FIG. 14, the electronic device 10 may include a display module 11, a processor 12, a memory device 13, and a power module 14.

The display device 1 or 1′ according to embodiments may be applied to various electronic devices. In an embodiment, the electronic device 10 may include the display device 1 of FIG. 1. In an embodiment, the electronic device 10 may further include modules or devices having other additional functions in addition to the display device 1. In an embodiment, the electronic device 10 may include the display device 1′ of FIG. 8. In an embodiment, the electronic device 10 may further include modules or devices having other additional functions in addition to the display device 1'.

The processor 12 may include at least one of a central processing unit (CPU), an application processor (AP), a graphic processing unit (GPU), a communication processor (CP), an image signal processor (ISP), and controller. The processor 12 may include one or more processors.

In an embodiment, the processor 12 may provide the input control signal CONT of FIG. 1 and the input image data IMG of FIG. 1 to the driving controller 200 included in the display device 1 of FIG. 1.

In an embodiment, the processor 12 may provide the input control signal CONT of FIG. 8 and the input image data IMG of FIG. 8 to the driving controller 200′ included in the display device 1′ of FIG. 8.

In an embodiment, the processor 12 may be provided as two or more forms in terms of functionality or structure. For example, the processor 12 may include a main processor in the form of a first driving chip including the central processing unit and an auxiliary processor in the form of a second driving chip including the controller that receives an image signal from the main processor and processes the image signal to conform interface specifications of the display module 11. The auxiliary processor may include the driving controller 200 included in the display device 1 of FIG. 1 or the driving controller 200′ included in the display device 1′ of FIG. 8. For example, the main processor may provide the input control signal CONT of FIG. 1 and the input image data IMG of FIG. 1 to the auxiliary processor. For example, the main processor may provide the input control signal CONT of FIG. 8 and the input image data IMG of FIG. 8 to the auxiliary processor, The auxiliary processor may process the image signal based on the input control signal CONT and the input image data IMG.

The memory device 13 may include at least one of a non-volatile memory device and a volatile memory device. Data information for an operation of the display module 11 or the processor 12 may be stored in the memory device 13. In an example in which the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel.

The power module 13 may include a power supply module, such as a power adapter or a battery device, and a power conversion module that converts power supplied by the power supply module and generates power for the operation of the electronic device 10.

At least one of the components of the electronic device 10 may be included in the display device 1 or 1′. In some aspects, some of individual modules functionally included in one module may be included in the display device and others may be provided separately from the display device. For example, the display device 1 or 1′ may include the display module 11, and the processor 12, the memory device 13, and the power module 14 may be provided in the form of other devices in the electronic device 10, other than the display device 1 or 1′.

Referring to FIG. 15, the various electronic devices having the display device 1 may include an image display electronic device such as a smart phone 10_1a, a tablet PC 10_1b, a laptop computer 10_1c, a TV 10_1d, a desk monitor 10_1e, and the like. In some aspects, the various electronic devices may include a wearable electronic device including the display module such as smart glasses 10_2a, a head mounted display 10_2b, a smart watch 10_2c, and the like. In some aspects, the various electronic device may include a vehicle electronic device 10_3 including the display module, such as an instrument panel, a center fascia, a center information display (CID) on a dashboard, a room mirror display, and the like. The electronic device 10 is not limited to the image display electronic device, the wearable electronic device and the vehicle electronic device 10_3.

The present inventive concepts may be applied to a display device and an electronic device including the display device. For example, the present inventive concepts may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, or the like.

The foregoing is illustrative of the inventive concept and is not to be construed as limiting thereof. Although example embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display device comprising:
a display panel comprising a first pixel which emits light of a first color, a second pixel which emits light of a second color, and a third pixel which emits light of a third color;
a data driver which outputs a data voltage to the first pixel, the second pixel, and the third pixel;
a gate driver which outputs a gate signal to the first pixel, the second pixel, and the third pixel;
a first emission driver which outputs a first emission signal to the first pixel;
a second emission driver which outputs a second emission signal to the second pixel and the third pixel; and
a driving controller which controls the data driver, the gate driver, the first emission driver, and the second emission driver,
wherein the driving controller:
determines a first emission duty of the first emission signal based on an emission efficiency of the first pixel;
controls the first emission driver such that the first emission driver outputs the first emission signal according to the first emission duty;
determines a second emission duty of the second emission signal based on an emission efficiency of the second pixel; and
controls the second emission driver such that the second emission driver outputs the second emission signal according to the second emission duty.

2. The display device of claim 1, wherein the driving controller:
determines the first emission duty based on a first maximum efficiency which is a maximum value of the emission efficiency of the first pixel within an emission efficiency determination range; and
determines the second emission duty based on a second maximum efficiency which is a maximum value of the emission efficiency of the second pixel within the emission efficiency determination range.

3. The display device of claim 2, wherein the driving controller:
determines a first current density corresponding to the first maximum efficiency;
determines the first emission duty based on the first current density;
determines a second current density corresponding to the second maximum efficiency; and
determines the second emission duty based on the second current density.

4. The display device of claim 3, wherein the driving controller:
determines a first maximum current, which is a maximum value of a current which flows through the first pixel, based on the first current density; and
determines a second maximum current, which is a maximum value of a current which flows through the second pixel, based on the second current density.

5. The display device of claim 4, wherein the driving controller:
determines the first emission duty based on the first maximum current; and
determines the second emission duty based on the second maximum current.

6. The display device of claim 5, wherein:
the first current density is greater than the second current density,
the first maximum current is greater than the second maximum current, and
the first emission duty is less than the second emission duty.

7. A display device comprising:
a display panel comprising a first pixel which emits light of a first color, a second pixel which emits light of a second color, and a third pixel which emits light of a third color;
a data driver which outputs a data voltage to the first pixel, the second pixel, and the third pixel;
a gate driver which outputs a gate signal to the first pixel, the second pixel, and the third pixel;
a first emission driver which outputs a first emission signal to the first pixel;
a second emission driver which outputs a second emission signal to the second pixel;
a third emission driver which outputs a third emission signal to the third pixel; and
a driving controller which controls the data driver, the gate driver, the first emission driver, the second emission driver, and the third emission driver,
wherein the driving controller:
determines a first emission duty of the first emission signal based on an emission efficiency of the first pixel;
controls the first emission driver such that the first emission driver outputs the first emission signal according to the first emission duty;
determines a second emission duty of the second emission signal based on an emission efficiency of the second pixel;
controls the second emission driver such that the second emission driver outputs the second emission signal according to the second emission duty;
determines a third emission duty of the third emission signal based on an emission efficiency of the third pixel; and
controls the third emission driver such that the third emission driver outputs the third emission signal according to the third emission duty.

8. The display device of claim 7, wherein the driving controller:
determines the first emission duty based on a first maximum efficiency which is a maximum value of the emission efficiency of the first pixel within an emission efficiency determination range;
determines the second emission duty based on a second maximum efficiency which is a maximum value of the emission efficiency of the second pixel within the emission efficiency determination range; and
determines the third emission duty based on a third maximum efficiency which is a maximum value of the emission efficiency of the third pixel within the emission efficiency determination range.

9. The display device of claim 8, wherein the driving controller:
determines a first current density corresponding to the first maximum efficiency;
determines the first emission duty based on the first current density;
determines a second current density corresponding to the second maximum efficiency;
determines the second emission duty based on the second current density;
determines a third current density corresponding to the third maximum efficiency; and
determines the third emission duty based on the third current density.

10. The display device of claim 9, wherein the driving controller:
determines a first maximum current, which is a maximum value of a current which flows through the first pixel, based on the first current density;
determines a second maximum current, which is a maximum value of a current which flows through the second pixel, based on the second current density; and
determines a third maximum current, which is a maximum value of a current which flows through the third pixel, based on the third current density.

11. The display device of claim 10, wherein the driving controller:
determines the first emission duty based on the first maximum current;
determines the second emission duty based on the second maximum current; and
determines the third emission duty based on the third maximum current.

12. The display device of claim 11, wherein:
the first current density is greater than the second current density,
the second current density is greater than the third current density,
the first maximum current is greater than the second maximum current,
the second maximum current is greater than the third maximum current,
the first emission duty is less than the second emission duty, and
the second emission duty is less than the third emission duty.

13. The display device of claim 12, wherein:
a driving mode of the display device comprises:
a first driving mode, in which a maximum luminance for a maximum gray-level is a first maximum luminance, and
a second driving mode, in which the maximum luminance for the maximum gray-level is a second maximum luminance higher than the first maximum luminance,
the first emission duty of the first emission signal in the second driving mode is greater than the first emission duty of the first emission signal in the first driving mode,
the second emission duty of the second emission signal in the second driving mode is greater than the second emission duty of the second emission signal in the first driving mode, and
the third emission duty of the third emission signal in the second driving mode is greater than the third emission duty of the third emission signal in the first driving mode.

14. The display device of claim 13, wherein:
the first maximum current in the first driving mode is equal to the first maximum current in the second driving mode,
the second maximum current in the first driving mode is equal to the second maximum current in the second driving mode, and
the third maximum current in the first driving mode is equal to the third maximum current in the second driving mode.

15. An electronic device comprising:
a processor which generates an input control signal and input image data;
a display panel comprising a first pixel which emits light of a first color, a second pixel which emits light of a second color, and a third pixel which emits light of a third color;
a data driver which outputs a data voltage to the first pixel, the second pixel, and the third pixel;
a gate driver which outputs a gate signal to the first pixel, the second pixel, and the third pixel;
a first emission driver which outputs a first emission signal to the first pixel;
a second emission driver which outputs a second emission signal to the second pixel;
a third emission driver which outputs a third emission signal to the third pixel; and
a driving controller which controls the data driver, the gate driver, the first emission driver, the second emission driver, and the third emission driver based on the input control signal and the input image data,
wherein the driving controller:
determines a first emission duty of the first emission signal based on an emission efficiency of the first pixel;
controls the first emission driver such that the first emission driver outputs the first emission signal according to the first emission duty;
determines a second emission duty of the second emission signal based on an emission efficiency of the second pixel;
controls the second emission driver such that the second emission driver outputs the second emission signal according to the second emission duty;
determines a third emission duty of the third emission signal based on an emission efficiency of the third pixel; and
controls the third emission driver such that the third emission driver outputs the third emission signal according to the third emission duty.

16. The electronic device of claim 15, wherein the driving controller:
determines the first emission duty based on a first maximum efficiency which is a maximum value of the emission efficiency of the first pixel within an emission efficiency determination range;
determines the second emission duty based on a second maximum efficiency which is a maximum value of the emission efficiency of the second pixel within the emission efficiency determination range; and
determines the third emission duty based on a third maximum efficiency which is a maximum value of the emission efficiency of the third pixel within the emission efficiency determination range.

17. The electronic device of claim 16, wherein the driving controller:
determines a first current density corresponding to the first maximum efficiency;
determines the first emission duty based on the first current density;
determines a second current density corresponding to the second maximum efficiency;
determines the second emission duty based on the second current density;
determines a third current density corresponding to the third maximum efficiency; and
determines the third emission duty based on the third current density.

18. The electronic device of claim 17, wherein the driving controller:
determines a first maximum current, which is a maximum value of a current which flows through the first pixel, based on the first current density;
determines a second maximum current, which is a maximum value of a current which flows through the second pixel, based on the second current density; and
determines a third maximum current, which is a maximum value of a current which flows through the third pixel, based on the third current density.

19. The electronic device of claim 18, wherein the driving controller:
determines the first emission duty based on the first maximum current;
determines the second emission duty based on the second maximum current; and
determines the third emission duty based on the third maximum current.

20. The electronic device of claim 19, wherein:
the first current density is greater than the second current density,
the second current density is greater than the third current density,
the first maximum current is greater than the second maximum current,
the second maximum current is greater than the third maximum current,
the first emission duty is less than the second emission duty, and
the second emission duty is less than the third emission duty.
